(19) United States
(12) Patent Application Publication
(10) Pub. No.: US 2025/0028214 A1
(43) Pub. Date: Jan. 23, 2025

(54) ELECTROCHROMIC VACUUM INSULATING GLASS UNITS

(71) Applicant: View, Inc., Milpitas, CA (US)

(72) Inventor: Rao P. Mulpuri, Saratoga, CA (US)

(73) Assignee: View, Inc., Milpitas, CA (US)

(21) Appl. No.: 18/688,209

(22) PCT Filed: Sep. 27, 2022
(86) PCT No.: PCT/US2022/044933

§ 371 Date: Feb. 29, 2024

Related U.S. Application Data
(60) Provisional application No. 63/261,695, filed on Sep. 27, 2021.

(51) Int. Cl. G02F 1/157; G02F 1/161

(52) U.S. Cl. CPC G02F 1/157; G02F 1/161

(57) ABSTRACT

Electrochromic vacuum insulated glass units and assemblies thereof are described. The electrochromic vacuum insulated glass unit comprises a first electrochromic device and a first vacuum insulated glass unit comprising a first substrate and a second substrate, wherein the first electrochromic device is in or on the first vacuum insulated glass unit.

### CROSS-REFERENCE TO RELATED APPLICATION

This application claims priority to and benefit of U.S. Provisional Patent Application 63/261,695, filed on Sep. 27, 2021; which is hereby incorporated by reference in its entirety and for all purposes.

### FIELD

Embodiments disclosed herein relate generally to insulated glass units, vacuum insulating glass units, and windows with optically switchable devices.

### BACKGROUND

Electrochromism is a phenomenon in which a material exhibits a reversible electrochemically-mediated change in an optical property when placed in a different electronic state, typically by being subjected to a voltage change. The optical property is typically one or more of color, transmittance, absorbance, and reflectance. One well known electrochromic material is tungsten oxide (WO₃). Tungsten oxide is a cathodic electrochromic material in which a coloration transition, transparent to blue, occurs by electrochemical reduction.

Electrochromic materials may be incorporated into, for example, windows for home, commercial and other uses. The color, transmittance, absorbance, and/or reflectance of such windows may be changed by inducing a change in the electrochromic material, that is, electrochromic windows are windows that can be darkened or lightened electronically. A small voltage applied to an electrochromic device of the window will cause them to darken; reversing the voltage causes them to lighten. This capability allows control of the amount of light that passes through the windows, and presents an opportunity for electrochromic windows to be used as energy-saving devices.

While electrochromism was discovered in the 1960s, electrochromic devices, and particularly electrochromic windows, still unfortunately suffer various problems and have not begun to realize their full commercial potential despite many recent advances in electrochromic technology, apparatus and related methods of making and/or using electrochromic devices.

### SUMMARY

Certain aspects pertain to thin-film devices, for example, electrochromic devices for windows, and methods of manufacturing are described. Particular focus is given to windows having a vacuum insulated glass unit and methods for fabricating windows having a vacuum insulated glass unit.

Certain aspects pertain to electrochromic vacuum insulated glass units (EC-VGUs) comprising one or more electrochromic devices and one or more vacuum insulated glass units. In certain aspects, a first electrochromic device is in or on a first vacuum insulated glass unit. In one of these aspects, the electrochromic device is on a inner surface within an evacuated volume of the first vacuum insulated glass unit. In another aspect, the electrochromic device is not within the evacuated volume.

Certain aspects pertain to electrochromic vacuum insulated glass units. In certain aspects, an electrochromic vacuum insulated glass unit includes a first electrochromic device and a first vacuum insulated glass unit. In some of these aspects, the first vacuum insulated glass unit includes a first substrate and a second substrate. In one aspect, the electrochromic vacuum insulated glass unit also includes a third substrate, a spacer, and a seal between the spacer and the first vacuum insulated glass unit and between the spacer and the third substrate.

These and other features and advantages will be described in further detail below, with reference to the associated drawings.

### BRIEF DESCRIPTION OF THE DRAWINGS

The following detailed description can be more fully understood when considered in conjunction with the drawings in which:

FIG. 1A depicts a schematic drawing of a cross-sectional view an electrochromic lite, according to implementations.

FIG. 1B depicts a schematic drawing of another cross-sectional view of the electrochromic lite of FIG. 1A, according to implementations.

FIG. 1C depicts a schematic drawing of a plan view of the electrochromic lite of

FIG. 1A, according to implementations.

FIG. 2A depicts a schematic drawing of a cross-sectional view of an example of an insulated glass unit with an electrochromic lite, according to implementations.

FIG. 2B depicts a schematic drawing of a cross-sectional view of an example of an insulated glass unit with a laminate electrochromic lite, according to implementations.

FIG. 3 depicts a schematic drawing of operations of an example of a process for fabricating an insulated glass unit, according to implementations.

FIG. 4 depicts a cross-sectional view of an insulated glass unit fabricated by, for example, the process schematically depicted in FIG. 3, according to implementations.

FIG. 5 depicts a schematic drawing of operations of an example of a process for fabricating an electrochromic insulated glass unit (EC-IGU), according to implementations.

FIG. 6 depicts a schematic drawing of a cross-sectional view of an example of an electrochromic vacuum insulated glass unit (EC-VGU), according to implementations.

FIG. 7 depicts a schematic drawing of a cross-sectional view of an example of an electrochromic vacuum insulated glass unit (EC-VGU), according to implementations.

FIG. 8 depicts a schematic drawing of a cross-sectional view of an example of an electrochromic vacuum insulated glass unit (EC-VGU) with a laminated mate lite, according to implementations.

FIG. 9 depicts a schematic drawing of a cross-sectional view of an example of an electrochromic vacuum insulated glass unit (EC-VGU) with a laminated mate lite, according to implementations.

FIG. 10 depicts a schematic drawing of a cross-sectional view of an example of an dual electrochromic vacuum insulated glass unit, according to implementations.

FIG. 11 depicts a schematic drawing of a cross-sectional view of an example of an dual electrochromic vacuum insulated glass unit, according to implementations.

FIG. 12 depicts a schematic drawing of a cross-sectional view of an example of an EC-VGU assembly including an inboard lite having a vacuum insulated glass unit and an outboard lite having a single substrate with an electrochromic device disposed thereon, according to implementations.

FIG. 13 depicts a schematic drawing of a portion of the cross-sectional view of an example of an EC-VGU assembly including an inboard lite having a vacuum insulated glass unit and an outboard lite having a single substrate with an electrochromic device disposed thereon, according to implementations.

FIG. 14 depicts a schematic drawing of a cross-sectional view of an example of an EC-VGU assembly with an inboard lite including a vacuum insulated glass unit and an outboard lite including a laminate with an electrochromic device coating, according to implementations.

FIG. 15 depicts a schematic drawing of a portion of the cross-sectional view of an example of an EC-VGU assembly with an inboard lite including a vacuum insulated glass unit and an outboard lite including a laminate with an electrochromic device coating, according to implementations.

FIG. 16 depicts a schematic drawing of a cross-sectional view of an example of an EC-VGU assembly with a single pane inboard lite and an outboard lite including a vacuum insulated glass unit with an electrochromic device coating, according to implementations.

FIG. 17 depicts a schematic drawing of a portion of the cross-sectional view of an EC-VGU assembly with a single pane inboard lite and an outboard lite including a vacuum insulated glass unit with an electrochromic device coating, according to implementations.

FIG. 18 depicts a schematic drawing of a cross-sectional view of an example of an EC-VGU assembly with an inboard lite having a laminate and an outboard lite including a vacuum insulated glass unit with an electrochromic device coating, according to implementations.

FIG. 19 depicts a schematic drawing of a portion of the cross-sectional view of an example of an EC-VGU assembly with an inboard lite having a laminate and an outboard lite including a vacuum insulated glass unit with an electrochromic device coating, according to implementations.

FIG. 20 depicts a schematic drawing of a cross-sectional view of an example of a dual EC-VGU assembly including an inboard lite having a first vacuum insulated glass unit with a first electrochromic device and an outboard lite having a second vacuum insulated glass unit with a second electrochromic device, according to implementations.

FIG. 21 depicts a schematic drawing of a portion of the cross-sectional view of an example of a dual EC-VGU assembly including an inboard lite having a first vacuum insulated glass unit with a first electrochromic device and an outboard lite having a second vacuum insulated glass unit with a second electrochromic device, according to implementations, according to implementations.

FIG. 22 depicts a schematic drawing of a cross-sectional view of an example of an EC-VGU assembly including an inboard lite with a substrate having an electrochromic device coating and an outboard lite including a vacuum insulated glass unit with another electrochromic device coating, according to implementations.

FIG. 23 depicts a schematic drawing of a portion of a cross-sectional view of an example of an EC-VGU assembly including an inboard lite with a substrate having an electrochromic device coating and an outboard lite including a vacuum insulated glass unit with another electrochromic device coating, according to implementations.

FIG. 24 depicts a schematic drawing depicting a cross-sectional view of an example of an EC-VGU assembly including an inboard lite having a laminate with an electrochromic device coating and an outboard lite including a vacuum insulated glass unit with another electrochromic device coating, according to implementations.

FIG. 25 depicts a schematic drawing depicting a portion of a cross-sectional view of an EC-VGU assembly is a schematic drawing depicting a cross-sectional view of an example of an EC-VGU assembly including an inboard lite having a laminate with an electrochromic device coating and an outboard lite including a vacuum insulated glass unit with another electrochromic device coating, according to implementations.

The figures and components therein may not be drawn to scale. Various components of the figures described herein may not be drawn to scale.

### DETAILED DESCRIPTION

For the purposes of brevity, embodiments are described in terms of electrochromic devices; however, the scope of the disclosure is not so limited. One of ordinary skill in the art would appreciate that methods described can be used to fabricate virtually any optically switchable device where electricity is used to switch the optical properties of the device. Certain embodiments are directed to optically switchable devices. In the simplest form, an optical device includes a substrate and one or more material layers. In one embodiment, an optical device includes a transparent substrate and two transparent conductor layers. In another embodiment, an optical device includes a transparent substrate upon which is deposited a transparent conductor layer (the lower conductor layer) and the other (upper) conductor layer is not transparent. In another embodiment, the substrate is not transparent, and one or both of the conductor layers is transparent. Some examples of optical devices include electrochromic devices, flat panel displays, photovoltaic devices, suspended particle devices (SPDs), liquid crystal devices (LCDs), electrophoretic devices, and the like. For context, a description of electrochromic devices is presented below. For convenience, all solid-state and inorganic electrochromic devices are described; however, embodiments are not limited in this way. The features illustrated in the drawings may not be to scale.

### I. Introduction to Electrochromic Devices and Insulated Glass Units (IGUs)

An electrochromic device is generally comprised of a first conductive layer, an electrochromic stack, and a second conductive layer. The electrochromic device stack may include an electrochromic layer, an ion conductor layer or region, and a counter electrode layer. In one aspect, the electrochromic device includes an ion conductor region formed where the electrochromic layer and the counter electrode meet, for example, through heating and/or other processing steps. In some embodiments, the electrochromic device contains no ion conductor region as deposited. In some aspects, an ion diffusion barrier lies between the electrochromic device and the substrate upon which the electrochromic device is disposed. In some cases, the substrate may be prefabricated with the diffusion barrier over underlying transparent material. For example, a sodium or potassium based glass substrate is typically fabricated with a diffusion barrier. In certain aspects, the ion diffusion barrier may be replaced by, function as, or be tandem with, one or more optical tuning layers, e.g. to modulate iridescence or other issues associated with stacked transparent layers having different indices of refraction or other optical properties. In these aspects, the first conductive layer, the electrochromic device stack, and the second conductive layer are deposited over the diffusion barrier prefabricated on the substrate. In other cases, the substrate may be prefabricated with both a diffusion barrier over the underlying transparent material and a first conductive layer over the diffusion barrier. Alternatively, the diffusion barrier may be omitted, for example, where the substrate is alkali free glass and no diffusion barrier is necessary, in such cases optical tuning layers may be used. An electrochromic lite typically includes at least one substrate with an electrochromic device disposed thereon.

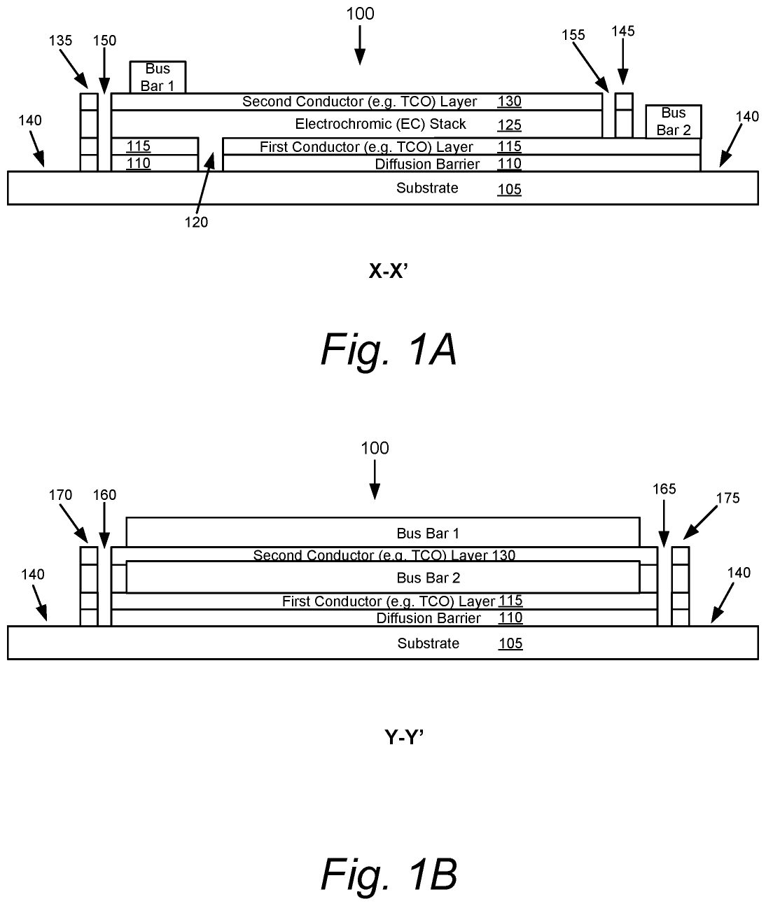

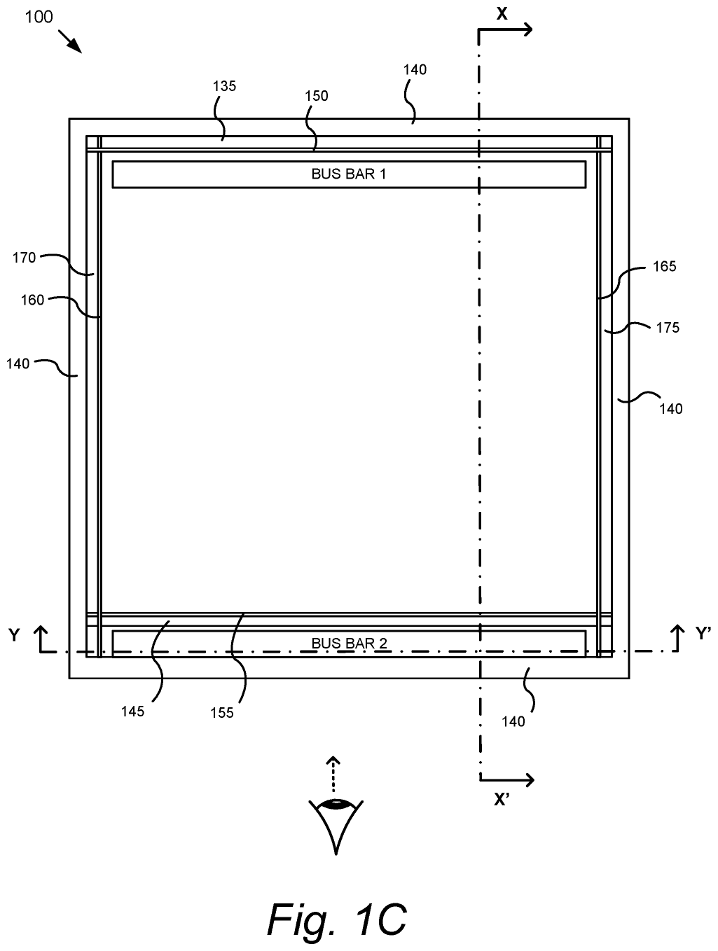

A particular example of an electrochromic lite 100 is described with reference to FIGS. 1A-1C. FIG. 1A depicts a cross-sectional representation (see section cut X-X′ in FIG. 1C) of electrochromic lite 100, which is fabricated starting with a substrate 105 such as, e.g., a glass sheet. FIG. 1B depicts another cross-sectional representation (see section cut Y-Y′ in FIG. 1C) of electrochromic lite 100. FIG. 1C depicts a plan view of electrochromic lite 100. Electrochromic lite 100 includes an electrochromic device disposed on the substrate 105. The electrochromic device may be formed by depositing layers on the substrate 105. The electrochromic device includes a first transparent conductive layer 115, an electrochromic stack 125, and a second transparent conductive layer 130. In the illustrated example, the first transparent conductive layer 115 including a transparent conductive oxide (TCO) material and the second transparent conductive layer 115 including a transparent conductive oxide (TCO) material. The substrate 105 also has a diffusion barrier layer, 110, formed on the substrate 105 and the first transparent conductive layer 115 formed on the diffusion barrier layer 110. In other implementations, the substrate may be prefabricated with both the diffusion barrier and the first transparent conductive layer formed on the underlying substrate. In some cases, the diffusion barrier may be omitted.

FIG. 1A shows the electrochromic lite 100 after fabrication of the electrochromic device on the substrate 105 and after the edge of the electrochromic device has been deleted to produce an edge delete area 140 around the perimeter of the electrochromic lite 100. Edge deletion refers to removing one or more material layers from the electrochromic device about some perimeter portion of the substrate. Typically, though not necessarily, edge deletion removes material down to and including the first conductor layer (e.g., the first conductor layer 115 in the example depicted in FIGS. 1A-1C) and may include removal of any diffusion barrier layer(s) down to the substrate itself. In FIGS. 1A-1B, the electrochromic lite 100 has also been laser scribed and a first bus bar (“Bus Bar 1”) is formed on or attached to the second conductor layer 130 and a second bus bar (“Bus Bar 2”) is formed on or attached to the first conductor layer 115.

In the illustrated example, an edge deletion process has removed both first conductor layer 115 and diffusion barrier layer 110, but in other implementations, only the first conductor layer is removed, leaving the diffusion barrier layer intact. The first conductor layer and second conductor layer may sometimes be referred to herein as the “electrodes” of the electrochromic device.

In the illustrated example, the diffusion barrier layer 110 is formed, and then the first conductor layer 115, an electrochromic (EC) stack 125 (e.g., a stack having an electrochromic layer, an ion conductor layer or material, and a counter electrode layer), and a second conductor layer 130, are formed on the substrate 105. The electrochromic (EC) stack 125 may have an electrochromic layer, an ion conductor layer or material, and a counter electrode layer. In other implementations, the substrate may be prefabricated with both the diffusion barrier and the first conductor layer formed over the underlying substrate. In one example, one or more layers of first conductor layer 115, electrochromic stack 125, and second conductor layer 130 are deposited in an all vacuum integrated apparatus.

In certain embodiments, one or more layers may be formed on a substrate (e.g., a glass sheet) in an integrated deposition system where the substrate does not leave the integrated deposition system at any time during fabrication of the layer(s). In one embodiment, an electrochromic device including an electrochromic stack and a second conductor layer may be fabricated in the integrated deposition system where the substrate does not leave the integrated deposition system at any time during fabrication of the material layers. In one case, the first conductor layer may also be formed using the integrated deposition system where the substrate does not leave the integrated deposition system during deposition of the electrochromic stack, and the conductor layer(s). In one embodiment, all of the layers (e.g., a diffusion barrier, a first conductor layer, an electrochromic stack, and a second conductor layer) are deposited in the integrated deposition system where the substrate does not leave the integrated deposition system during deposition. In this example, prior to deposition of electrochromic stack 125, an isolation trench, 120, may be cut through first conductor 115 and diffusion barrier 110. Trench 120 is made in contemplation of electrically isolating an area of first conductor layer 115 that will reside under bus bar 1 after fabrication is complete (see FIG. 1A). Trench 120 is sometimes referred to as an “L1” scribe, because it may be the first laser scribe in certain processes. This is done to avoid charge buildup and coloration of the electrochromic device under the bus bar, which can be undesirable. This undesirable result is explained in more detail below and was the impetus for certain embodiments described herein. That is, certain embodiments are directed toward eliminating the need for isolation trenches, such as trench 120, for example, to avoid charge buildup under a bus bar, but also to simplify fabrication of the device by reducing or even eliminating laser isolation scribe steps.

After formation of the electrochromic device, edge deletion processes and additional laser scribing are performed. FIGS. 1A and 1B depict areas 140 where the electrochromic device has been removed, in this example, from a perimeter region surrounding laser scribe trenches, 150, 155, 160 and 165. Laser scribes trenches 150, 160 and 165 are sometimes referred to as “L2” scribes, because they may be the second scribes in certain processes. Laser scribe trench 155 is sometimes referred to as the “L3” scribe, because it may be the third scribe in certain processes. Laser scribe trench 155 passes through second conductor layer 130, and in this example (but not necessarily) the electrochromic stack 125, but not the first conductor layer 115. Laser scribe trenches 150, 155, 160, and 165 are formed to isolate portions of the electrochromic device, 135, 145, 170, and 175, which were potentially damaged during edge deletion processes, from the operable electrochromic device. In one embodiment, laser scribe trenches 150, 160, and 165 pass through the first conductor layer 115 to aid in isolation of the device (laser scribe trench 155 does not pass through the first conductor layer 115, otherwise it would cut off Bus Bar 2's electrical communication with the first conductor layer 115 and thus the electrochromic stack 125). In some embodiments, such as those depicted in FIGS. 1A-1C, laser scribe trenches 150, 160, and 165 may also pass through a diffusion barrier 110.

The laser or lasers used for the laser scribe processes are typically, but not necessarily, pulse-type lasers, for example, diode-pumped solid state lasers. For example, the laser scribe processes can be performed using a suitable laser. Some examples of suppliers that may provide suitable lasers include IPG Photonics Corp. (of Oxford, Massachusetts), Ekspla (of Vilnius, Lithuania), TRUMPF Inc. (Farmington, Connecticut), SPI Lasers LLC (Santa Clara, California), Spectra-Physics Corp. (Santa Clara, California), nLIGHT Inc. (Vancouver, Washington), and Fianium Inc. (Eugene, Oregon). Certain scribing steps can also be performed mechanically, for example, by a diamond tipped scribe; however, certain embodiments describe depth control during scribes or other material removal processing, which is well controlled with lasers. For example, in one embodiment, edge deletion is performed to the depth of the first conductor layer (e.g., a first transparent conductive oxide (TCO) layer), in another embodiment edge deletion is performed to the depth of a diffusion barrier (the first conductor layer is removed), in yet another embodiment edge deletion is performed to the depth of the substrate (all material layers removed down to the substrate). In certain embodiments, variable depth scribes are described.

After laser scribing is complete, one or more bus bars are formed or attached. In the illustrated example depicted in FIGS. 1A-1C, a first non-penetrating bus bar (“Bus Bar 1”) is applied to the second conductor layer 130 and a second non-penetrating (“Bus Bar 2”) is applied to the first conductor layer 115. The second non-penetrating may be applied in an area of the first conductor layer 115 where the electrochromic device, including the electrochromic stack 125 and the second conductor layer 130, was not deposited (for example, from a mask protecting the first conductor layer 115 from device deposition) or, in this example, where an edge deletion process (e.g. laser ablation using an apparatus e.g. having a XY or XYZ galvanometer) was used to remove material down to the first conductor layer.

In FIGS. 1A-1C, the first bus bar (“Bus Bar 1”) and the second bus bar (“Bus Bar 2”) are non-penetrating bus bars. A non-penetrating bus bar is one that does not penetrate into the layers, but rather makes electrical and physical contact on the surface of a conductive layer, for example, a first conductor layer and/or a second conductor layer. A typical example of a non-penetrating bus bar is a conductive ink, e.g. a silver-based ink, applied to the appropriate conductive surface. In other implementation, the first bus bar and the second bus bar may be penetrating bus bars. A penetrating bus bar is one that may be pressed into (or soldered) and through one or more layers to make contact with a lower conductor layer, e.g. a transparent conductive oxide (TCO) layer located at the bottom of or below one or more layers of the electrochromic stack.

In certain implementations, conductor layers may be electrically connected to a non-penetrating bus bar, for example, a bus bar may be fabricated on a conductor layer with screen and lithography patterning methods. In one embodiment, electrical communication is established with the electrochromic device's transparent conducting layers via silk screening (or using another patterning method) a conductive ink followed by heat curing or sintering the conductive ink. Advantages to using the above described device configuration include simpler manufacturing, for example, and less laser scribing than techniques that use penetrating bus bars.

After one or more bus bars are fabricated or otherwise applied to the first and second conductive layers of the electrochromic device, in certain implementations the electrochromic lite may be integrated into an insulated glass unit (IGU), which may include, for example, wiring for the one or more bus bars and the like. In some implementations, one or both of the bus bars are located inside the finished IGU. For example, in some cases one or more both bus bars may be located in a primary seal area between the spacer and the substrate of the IGU. In some cases, the bus bars may be registered with the spacer that separates the lites of the IGU.

In FIGS. 1A-1C, the edge delete area 140 is used, at least in part, to make a seal with one face of a spacer used to form the primary seal of the IGU. Thus, the wires or other connection to the one or more bus bars may run between the spacer and the substrate. As a spacer may be made of metal, e.g., stainless steel, which is conductive, it is desirable to take steps to avoid short circuiting due to electrical communication between the bus bar and connector thereto and the metal spacer. Particular methods and apparatus for achieving this end are described in U.S. patent application Ser. No. 13/312,057 (now U.S. Pat. No. 8,711,465), filed Dec. 6, 2011, and titled “Improved Spacers for Insulated Glass Units,” which is hereby incorporated by reference in its entirety. In certain implementations, IGUs may have a perimeter edge of the electrochromic device, one or more bus bars, and/or one or more isolation scribes within the primary seal of the IGU.

In certain implementations, during fabrication of an insulated glass unit (IGU), a primary seal, which may include a gasket or a sealing material (e.g., PVB (polyvinyl butyral), PIB (polyisobutylene), or other suitable elastomer), may be formed between the inner surfaces of two lites and a spacer located between the two lites. The spacer may be located along the perimeter of, and between the lites. The spacer may be a metal spacer or other rigid material spacer such as a foam spacer. After the primary seal is formed, joining the lites to the spacer, a secondary seal may be formed around the outer perimeter of the primary seal. The secondary seal may be, for example, a polymeric material that resists water or other moisture and/or that adds structural support to the IGU. Typically, but not necessarily, a desiccant is included in the IGU, such as in the IGU frame and/or in the spacer, during assembly to absorb any moisture and/or organic volatiles that may diffuse from the sealant materials. In some examples, the primary seal surrounds the bus bars and the electrical connections to the bus bars extend through the primary seal. Typically, but not necessarily, the interior region is of the IGU is filled with an inert gas such as argon, e.g., for thermal insulation. The completed IGU may be installed in, for example, a frame or a curtain wall. The IGU may be connected to a source of electricity and one or more controllers to operate one or more devices in a window incorporating the IGU. For example, the IGU may be connected to one or more window controller for transitioning tint states of one or more electrochromic devices.

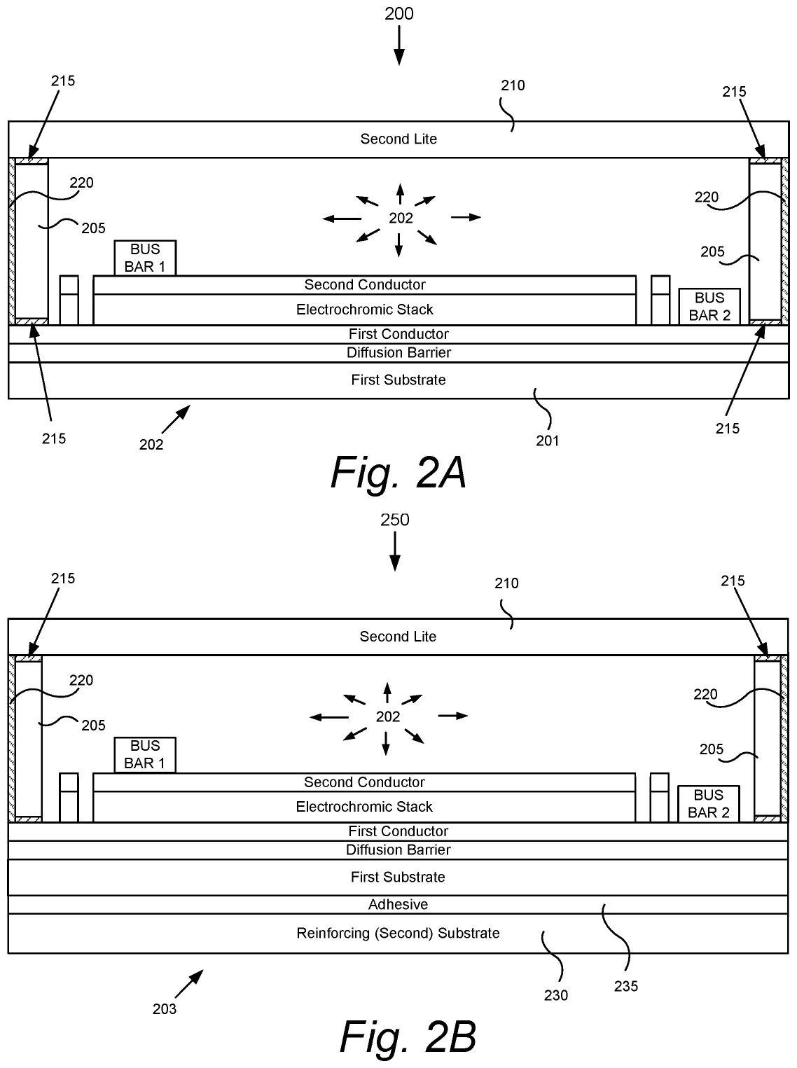

FIG. 2A depicts a schematic drawing of a cross-sectional view of an example of an electrochromic lite 202, e.g., the electrochromic lite 100 described in relation to FIGS. 1A-1C, that has been integrated into an insulated glass unit (IGU) 200. A spacer 205 is used to separate electrochromic lite 202 (also sometimes referred to as the “first lite”) from a second lite 210. Between spacer 205 and the first conductor layer (e.g., a layer of tin oxide material such as fluorinated tin oxide) of the electrochromic lite 202 is a primary seal material 215. This primary seal material 215 is also between spacer 205 and the second lite 210. Around the perimeter of spacer 205 is a secondary seal 220. Even though second lite 210 in IGU 200 is depicted as a non-electrochromic lite, the embodiments disclosed herein are not so limited. For example, second lite 210 may have an electrochromic device disposed thereon and/or one or more additional coatings such as a low-E coating and the like. In addition or alternatively, second lite 210 may be a laminate.

Alternatively, the first electrochromic lite may be a laminate, such as depicted in FIG. 2B. FIGS. 2B shows a s a schematic drawing of a cross-sectional view of an electrochromic lite 203, e.g., as may include the electrochromic lite 100 described in relation to FIGS. 1A-1C, that has been laminated to a reinforcing substrate 230, via an adhesive 235 such as a resin, and integrated into an insulated glass unit (IGU) 250. A spacer 205 is used to separate electrochromic lite 202 (also sometimes referred to as the “first lite”) from a second lite 210. Between spacer 205 and the first conductor layer of the electrochromic lite 202 is a primary seal material 215. This primary seal material 215 is also between spacer 205 and the second lite 210. Around the perimeter of spacer 205 is a secondary seal 220.

In the illustrated examples shown in FIGS. 2A and 2B, secondary seal 220 may be much thicker that depicted. The primary seal 215 and secondary seal 220 may aid in keeping moisture out of an interior region 202 (sometimes referred to as “interior volume”) of the insulated glass unit. They may also serve to prevent argon or other gas in the interior region 202 of the IGU from escaping. In certain implementations of the examples shown in FIGS. 2A and 2B, bus bar wiring/leads may traverse the primary and secondary seals for connection to a controller located outside the insulated glass unit. In FIGS. 2A and 2B, a first bus bar (“BUS BAR 1”) and a second bus bar (“BUS BAR 2”) are disposed within the sealed volume of the IGU.

In certain aspects, an electrochromic lite may be a laminate of two or more substrates. One or more of the substrates may be a thin glass layer, plastic layer, or combination thereof, e.g. one substrate is plastic and the other glass. In one example, the one substrate of a laminate includes a thin glass substrate with an electrochromic coating disposed thereon. Another substrate of the laminate may be thin glass and optionally have an electrochromic device thereon. The laminate may include a lamination adhesive at the interface between substrates. In one aspect, a laminate includes a laminate adhesive with properties that bind the adhering substrates irreversibly so that if the laminate is damaged the substrate pieces will stay adhered to the lamination adhesive.

In certain implementations, a lite includes a laminate having two substrates where each substrate has an electrochromic device coating deposited thereon. Such “dual pane” electrochromic device laminates may achieve darker tinting such as, e.g., 10% transmissivity, than if the laminate had a single electrochromic-coated substrate. Some examples of multi-pane windows with multiple electrochromic devices on one lite can be found in U.S. patent application Ser. No. 12/851,514 (now U.S. Pat. No. 8,270,059), titled “MULTI-PANE ELECTROCHROMIC WINDOWS” and filed on Feb. 9, 2012, which is hereby incorporated by reference in its entirety. In some cases, one or more of the substrates of a laminate are thin substrates such as thin glass substrates such as thin sheets of Gorilla® Glass and the like. The laminate may have a protective coating, such as a polymer, on one or both outside surfaces to protect against breakage of the thin glass substrates. By using thin flexible substrates, electrochromic laminates can be made in large sizes, be lightweight and yet strong. In another example, one substrate of a laminate may include an electrochromic device coating while the mate reinforcement substrate of the laminate may include a thermochromic coating and/or a photochromic coating. In this way one lite of the laminate allows for passive tinting, while the other lite provide active tinting to augment the passive tinting, or not, depending upon the need of the end user. Complimentary tinting also allows for each tintable coating, whether actively or passively tinting, to tint to a lesser degree, while together providing more tinting/shading than each coating could otherwise singly.

In embodiments with a laminate electrochromic lite, an electrochromic device coating may be disposed at the substrate interface and/or on one or both of the outer surfaces of the laminate substrates. In some aspects, locating an electrochromic device coating at a substrate interface between substrates can help protect the electrochromic device coating. In some cases, a substrate of the laminate may be prefabricated with a diffusion barrier over underlying transparent material. For example, EAGLE XG® Glass (EXG), Gorilla® Glass, or Willow® Glass are available with a transparent conducting layer in the form of an indium tin oxide (ITO) coating.

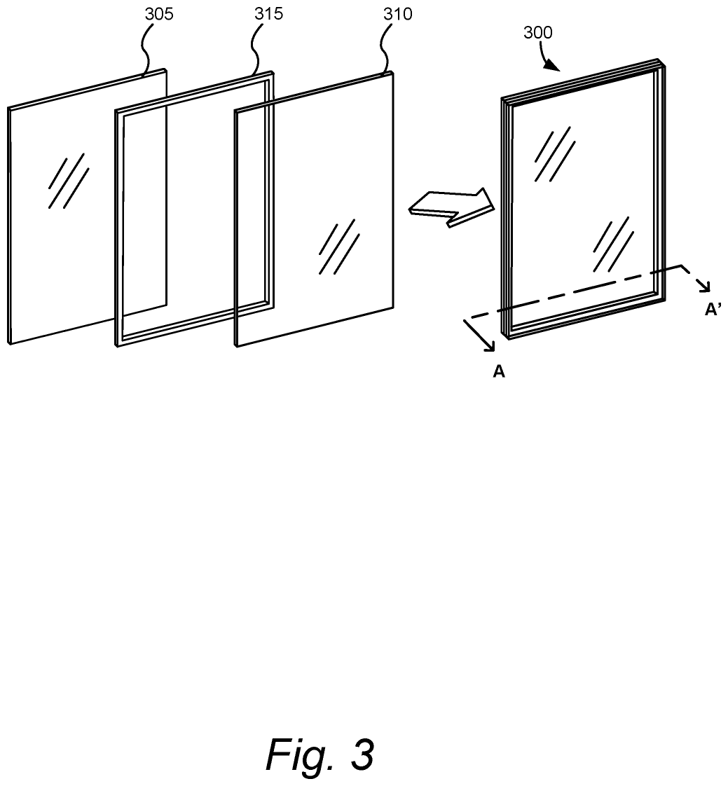

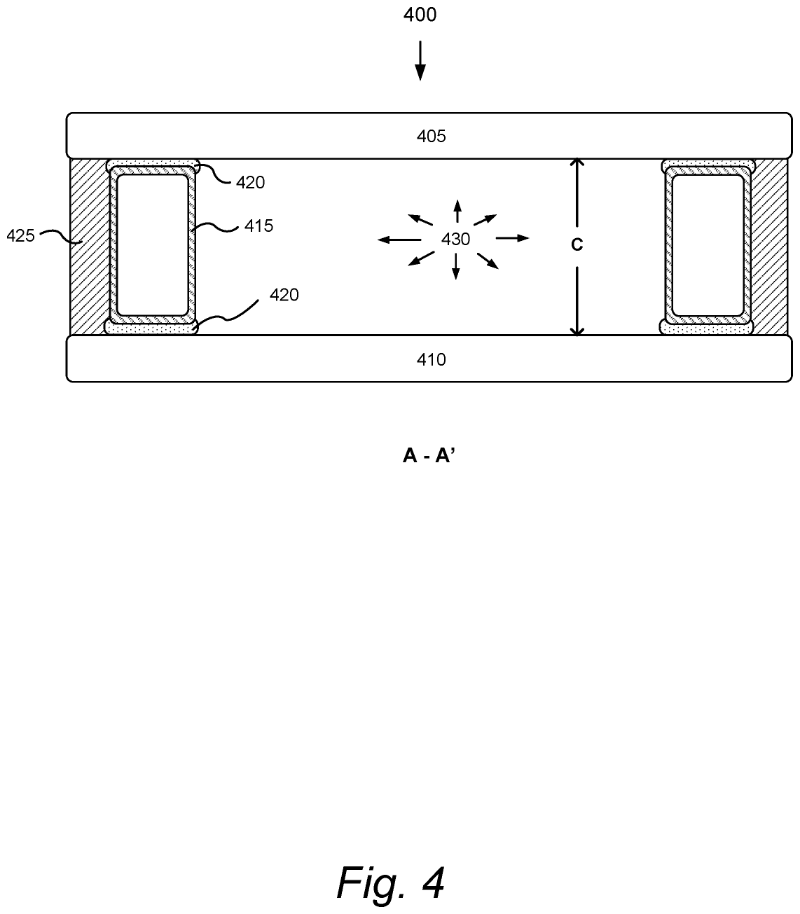

FIG. 3 depicts a schematic drawing of operations of an example of a process for fabricating an insulated glass unit 300, e.g., the insulated glass unit 400 described in relation to FIG. 4, according to implementations. IGU 300 includes a first lite 305, a spacer 315, and a second lite 310. When the three components are combined, where spacer 315 is sandwiched in between, and registered with, first lite 305 and second lite 310, an IGU 300 is formed.

FIG. 4 depicts a cross-sectional view of an insulated glass unit 400 fabricated by, for example, the process schematically depicted in FIG. 3, according to implementations. IGU 400 includes a first lite 405, a spacer 415, and a second lite 410. During fabrication, the spacer 415 is sandwiched in between, and registered with, first lite 405 and second lite 410. The IGU 400 has an interior region 430 defined by the interior faces of first lite 405 and second lite 410, and spacer 415. In FIG. 4, the first and second lites 410, 415 are depicted as separated by a distance “C.” IGU 400 includes a primary seal 420, e.g., an adhesive sealant, between the inner surfaces of first and second lites 405, 410 and the interior surfaces of spacer 415. Primary seal 420 may, for example, hermetically seal the interior region 430 and thus protect the interior of IGU 400 from moisture and the ambient. The interior region 430 may be filled with an inert gas, such as argon, for thermal insulation. The IGU 400 also incudes a secondary seal 425 with a sealant material applied around spacer 415 and between first and second lites 405, 410. Spacer 415 lies along the perimeter of, and has a length and a width smaller than, first and second lites 405, 410 leaving space between the perimeter edge of the lites 405, 410 and the outer edge to the spacer 415. This space may be filled with a sealant material to form secondary seal 425 as depicted in FIG. 4.

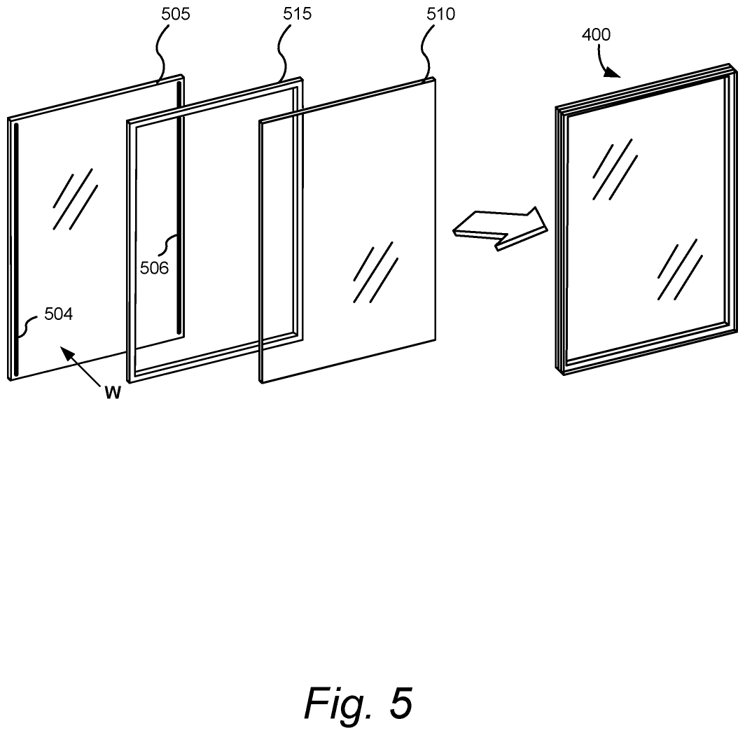

FIG. 5 depicts a schematic drawing of operations of an example of a process for fabricating an electrochromic insulated glass unit (EC-IGU) 500, according to certain implementations. In the EC-IGU process, an electrochromic lite 505 having an electrochromic device (not shown, but for example an electrochromic device on interior surface W) and a first bus bar 504 and a second bus bar 506, which deliver power to electrochromic device, is matched with another lite, 510. In other implementations, the EC-IGU may have multiple electrochromic devices, each with at least two bus bars.

During fabrication of EC-IGU 500, spacer 515 is sandwiched in between, and registered with, electrochromic (first) lite 505 and the other (second) lite 510. EC-IGU 500 has an associated interior region defined by the inner surfaces the lites 505, 510 and the inner surfaces of the spacer 515. In this case, spacer 515 is a sealing spacer. The EC-IGU 500 includes a primary seal including a sealing material between the spacer 510 and each lite 505, 510, where they adjoin in order to hermetically seal the interior region and thus protect the interior of EC-IGU 500 from moisture and other ambient environment factors. Once the lites 505, 510 are sealed to the spacer 515, a secondary sealing material may be applied around the perimeter edges of the EC-IGU 500 in order to impart not only further sealing from the ambient environment, but also to further structural rigidity of the EC-IGU 500. During fabrication, the interior region is filled with a gas for thermal insulation such as an inert gas (e.g., argon). An absorptive or reflective coating (e.g., an infrared absorptive coating) may also be applied to one or both of the lites 505, 510 of the EC-IGU 500 to provide further thermal insulative protection by absorbing or reflecting heat from, e.g., infrared wavelengths of the solar spectrum. The absorptive or reflective coating may provide some R value.

### II. Electrochromic Vacuum Insulated Glass Units (EC-VGUs)

Generally speaking, a vacuum insulated glass unit (VGU) includes a first substrate and a second substrate with one or more spacers sandwiched between. The VGU has an interior region that is defined by the interior faces of the first substrate and the second substrate, and each of the one or more spacers in the VGU. For example, in certain implementations a VGU may have a grid of spacers including an outer edge spacer and one or more internal spacers, e.g., across the viewable area. In this case, the VGU includes pockets of the interior region (space) between each of the spacers and the first and second substrates. During fabrication, the interior region is evacuated to form a vacuum or nearly a vacuum. The spacers function to prevent the two glass substrates from touching each other due to the vacuum, and, to maintain a uniform spacing between the substrates. The spacers may be transparent or not. Transparent spacers can be made from polycarbonate, high density polyethylene (HDPE) or other suitable polymers. Degassing of the polymer or any adhesives used to adhere them to the glass substrate(s) is to be avoided, as it can reduce the established vacuum and/or occlude the window if the gases condense therein.

In certain implementations, a VGU includes an electrochromic device on one or more of its substrates, e.g., to form an electrochromic vacuum insulated glass unit (EC-VGU). The electrochromic device may or may not be subjected to the vacuum of the unit. Since vacuum does not transfer heat, an EC-VGU provides superior thermal insulation as compared with a structure having a gas-filled interior region such as, for example, the IGU 300 shown in FIG. 3 or the EC-IGU 500 shown in FIG. 5. Moreover, with this improvement in thermal insulation properties, the distance between the substrates of a EC-VGU may be reduced, which reduces thickness of the EC-VGU. In addition, EC-VGUs of certain implementations have internal spacers across the viewable area to keep the substrates from touching due to the vacuum. These internal spacers provide structural stiffening that can allow the substrates of the EC-VGU to be thinner to reduce weight and have a slim profile. Additionally, there are benefits imparted by the electrochromic device, as heat and light can be modulated according to desired outcomes of, e.g., the building occupants.

During winter, a window with an EC-VGU assembly may provide more thermal insulating to reduce heat transferred outward and allow more natural light to enter the room than a window having three panes of separate glass sheets with inert gas filled in interior regions. A window with an EC-VGU assembly improves natural lighting in the room and allows heat to enter the room from solar radiation. In addition, a window with an EC-VGU assembly has improved sound proofing (better acoustic performance) over a window having three panes of separate glass sheets with gas-filled interior regions. Moreover, windows with EC-VGU assemblies can have a slim profile, which allows for retrofitting a building with insulated glass units installed.

Although examples of VGU assemblies are described herein with a lite having a VGU or a mating lite of an IGU with one or more electrochromic devices (e.g., an all solid-state and inorganic electrochromic device), it would be understood that other optically switchable devices may be implemented such as a liquid crystal device, a suspended particle device, an electrophoretic device, and the like.

An EC-VGU combines an electrochromic device with a vacuum thermal barrier for superior thermal insulation performance, and in some cases may also provide a thinner, and more light weight, cross-section. In its simplest form, and EC-VGU includes an electrochromic device on a transparent substrate, and, a vacuum insulated glass unit. The electrochromic device's transparent substrate may be one of a pair of substrates used in establishing the evacuated space of the VGU component, or not. As such the electrochromic device may or may not be exposed to the evacuated space of the VGU component.

In other aspects, a EC-VGU assembly may be part of a conventional IGU, having a inert gas volume. In such embodiments, for example, a first lite of the IGU is the VGU and a second lite registered therewith, a spacer, form an interior region with an inert gas, where at least one lite has an electrochromic device coating. The electrochromic device coating may be: 1) on the second lite, either on a surface facing the inert gas or the opposite face (in which case it may be protected within a laminate or other means of hermetic seal, or 2), on the first lite, which is the VGU, and thus either within the evacuated space or not, and if not then on the surface of the VGU facing the inert gas of the interior region filled therewith, or, on the surface facing away from the inert gas fill and hermetically protected in a laminate or by other means. While it may be advantageous to seal an EC device within the evacuated space of the VGU, it also may introduce more complexity in the fabrication process. In these aspects, thermal barriers are provided by both the vacuum of the VGU and from the interior region filled with an inert gas between the first and second lites. The vacuum barrier and a switchable EC barrier, as the EC device may be reflective, absorptive, or both. Various implementations of EC-VGU assemblies are described herein.

Fabrication of the aforementioned embodiments can occur in various combinations. In one example, an electrochromic lite is combined with a mate lite to form an EC-VGU, using know methods for forming conventional VGUs. The electrochromic lite may be a laminated construct or a single lite. The EC-VGU thus constructed can be used for windows as is (put into a framing system), or, further combined with another lite to form an IGU, where the EC-VGU serves as one lite of the IGU. In another example, an electrochromic lite, as a single substrate or in a laminate form, is combined with a conventional VGU, using methods of forming conventional IGUs, to make an EC-VGU that includes an inert gas filled volume. Various combinations are further described in reference to the figures herein, and, one of ordinary skill in the art would understand that conventional fabrication methods may be used to construct the described embodiments.

During fabrication of an EC-VGU assembly according to various implementations, an electrochromic (first) lite having a transparent substrate with an electrochromic device disposed thereon and a first bus bar and a second bus bar, which deliver power to the electrochromic device, is matched with another (second) lite having another transparent substrate. In other implementations, the EC-VGU may have multiple electrochromic devices, each with a pair of bus bars. EC-VGU has an interior region defined by the inner surfaces of the first and second lites and the interior surfaces of the spacer. The EC-VGU may include at least one outer sealing spacer. In some cases, the EC-VGU may also include one or more inner spacers, at least some of which may be located in the viewable area of the EC-VGU. The EC-VGU may also include a primary seal with a sealing material between the spacer and each of the lites, where they adjoin in order to hermetically seal the interior region. Once the lites are sealed to the spacer, a secondary sealing material may be applied around the perimeter edges of the EC-VGU. During or after the sealing operations, the interior region is evacuated to form a vacuum or near vacuum to provide insulation. In some cases, a non-switchable (passive) absorptive or reflective coating may be applied to one or both of the lites of the EC-VGU to provide further thermal insulative protection.

In certain implementations, an EC-VGU assembly may be in electrical communication with a power supply and/or to a controller for one or both of power and communication. The electrical communication may be via one or more wires and/or or wirelessly. In certain implementations, EC-VGU may be supported by a frame that is part of a window assembly. The frame or the EC-VGU may include a controller for controlling the electrochromic device such as an onboard window controller. Alternatively, the controller may be separate and in electrically communication with (wirelessly and/or by one or more wires) the window assembly. The controller may also be connected to one or more sensors, e.g., in the frame or in the EC-VGU.

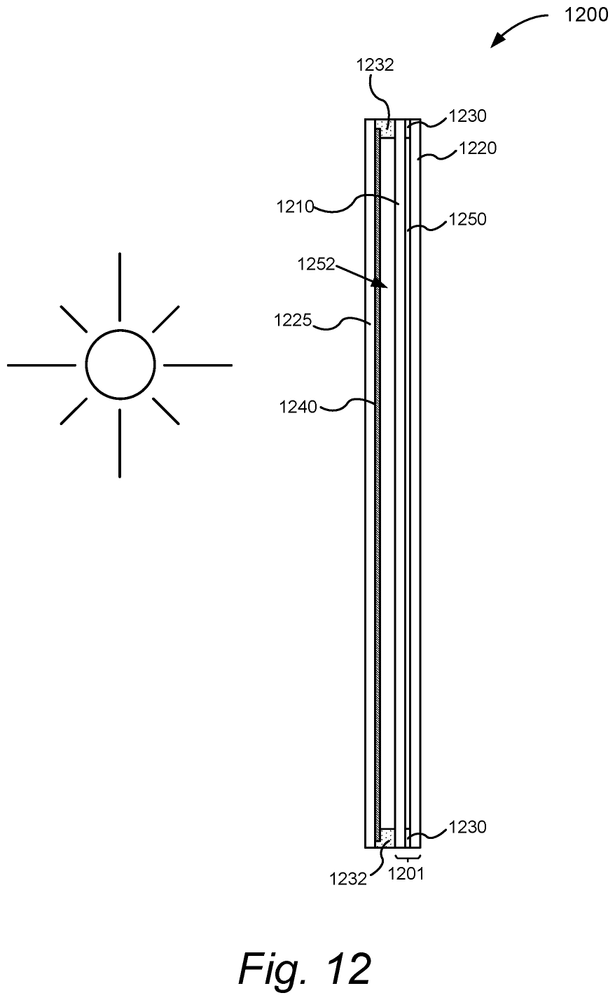

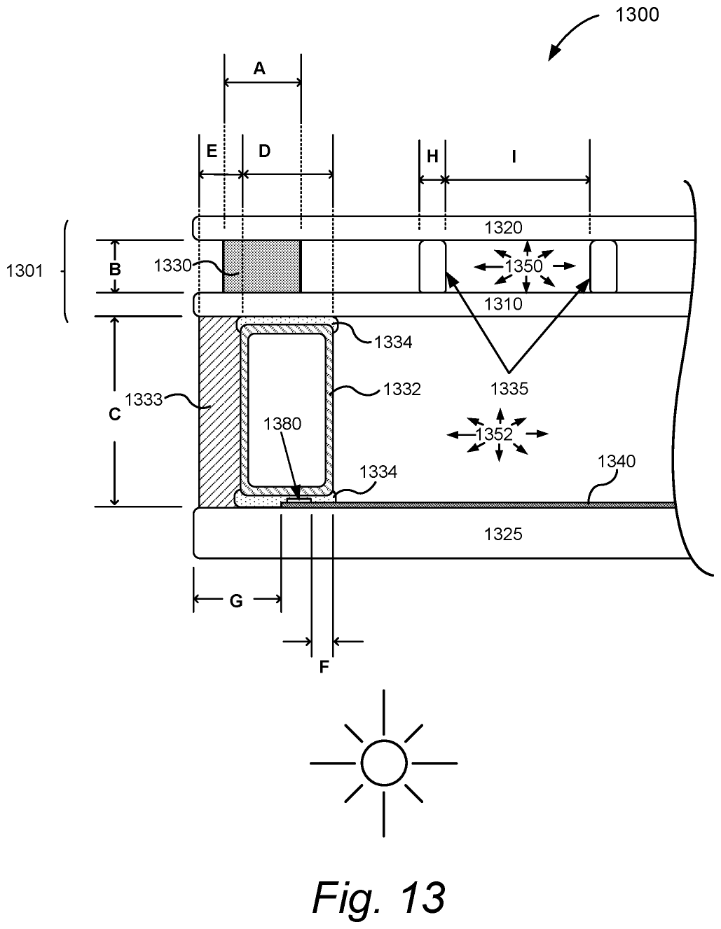

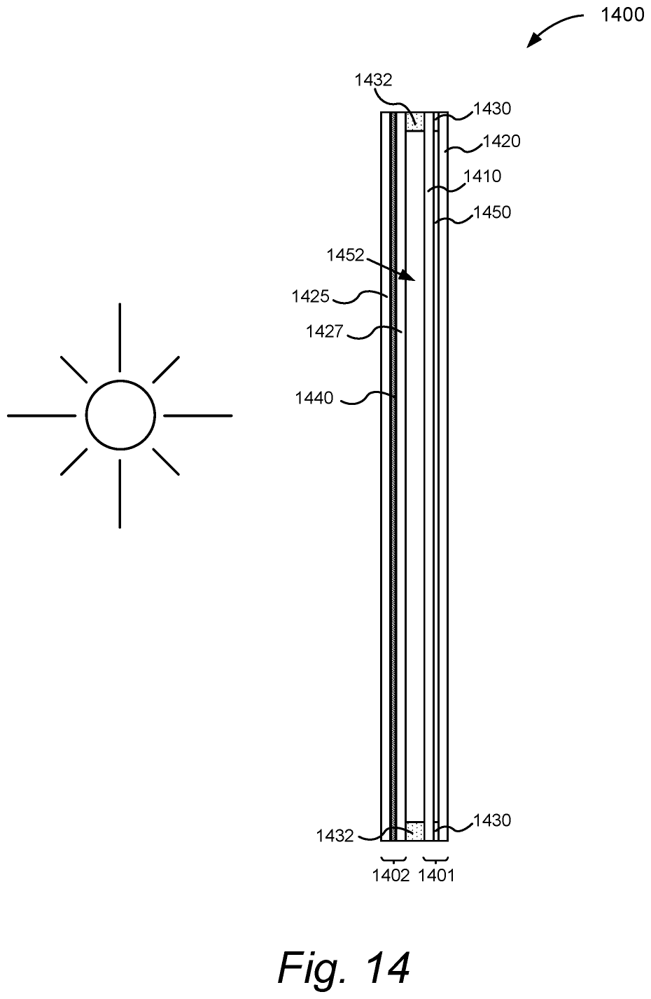

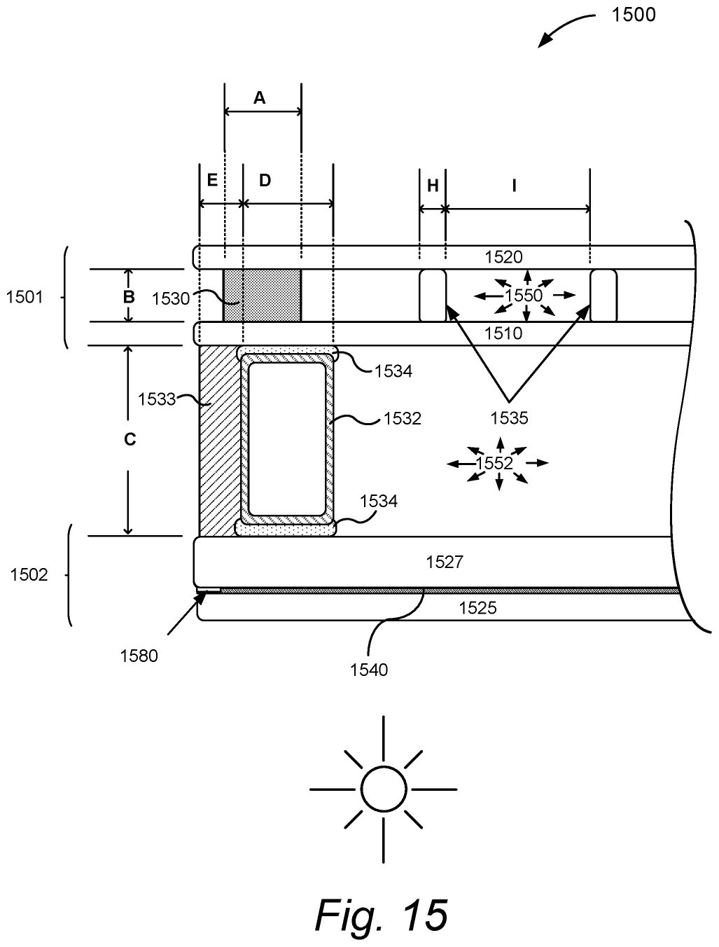

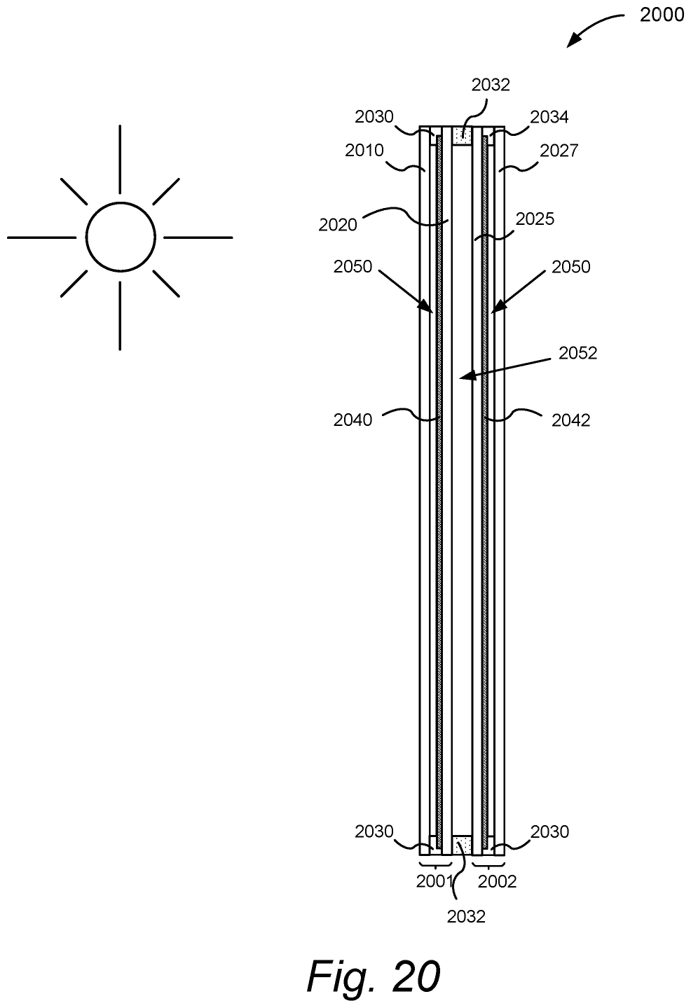

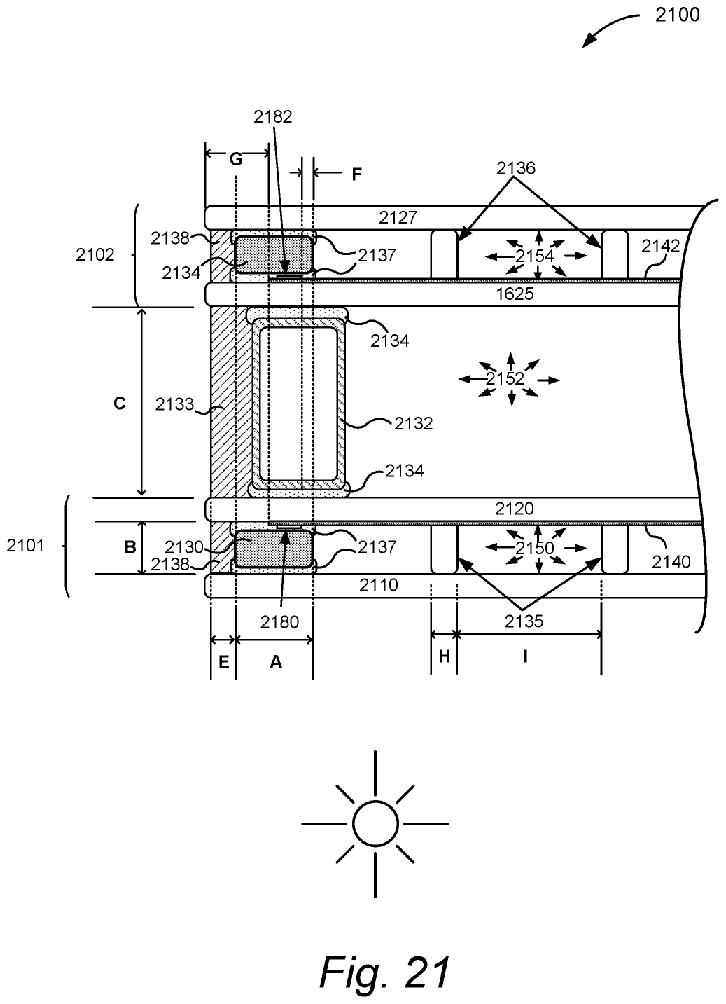

In certain examples, an EC-VGU assembly includes an inboard lite with a vacuum insulated glass unit and an outboard lite with at least one electrochromic device. For example, EC-VGU assembly 1201 in FIG. 12, EC-VGU assembly 1301 in FIG. 13, EC-VGU assembly 1401 in FIG. 14, EC-VGU assembly 1501 in FIG. 15, EC-VGU assembly 2002 in FIG. 20, and EC-VGU assembly 2102 in FIG. 21, each include an inboard lite with a VGU and an outboard lite with at least one electrochromic device. Configurations of EC-VGU assemblies with a VGU in the inboard lite may impart the benefit of minimizing thermal stress on the VGU in the inboard lite. For example, tinting of the at least one electrochromic device in the outboard may reduce thermal stress on the inboard lite. Reducing thermal stresses on the VGU in the inboard lite may improve its lifetime.

While a VGU in combination with an electrochromic device coating provides thermal insulation without the inert gas barrier of an IGU, in certain implementations an EC-VGU assembly (i.e., an assembly having an electrochromic device coating in combination with a VGU) may include an insulated glass unit (IGU) having an electrochromic device lite (EC lite) and another lite with a VGU (which may be thought of as an EC-VGU-IGU, however for brevity “EC-VGU” may be used herein). In this aspect, an inert gas is filled between the EC lite and the VGU lite (e.g., EC/vacuum/inert gas). In this example, a thermal barrier is provided at the vacuum between the substrates of the VGU and further thermal insulation is provided by the inert gas between the EC lite and VGU lite. The electrochromic device coating may or may not be part of the VGU construct. That is, the VGU can be a mate (second) lite in the IGU for an EC (first) lite counterpart. Additionally or alternatively, an electrochromic device coating may be part of a VGU that is a lite of an IGU. In another example, the VGU could be suspended within an IGU, in a triple lite construct, where the VGU is the middle lite of three lites, and the other two are either an electrochromic lite and a glass lite or two electrochromic lites. In yet another example, the suspended VGU includes the electrochromic device and the other two (outer) lites do not include an electrochromic device.

Some examples of EC-VGU assemblies may include an IGU with double or triple lites including at least one lite with a VGU having at least two substrates. Each lite of an EC-VGU assembly may include a single substrate, a VGU, and/or a laminate of multiple substrates. In one example, an EC-VGU assembly includes an IGU with an inboard lite having a VGU and an outboard lite having an electrochromic single pane (i.e. electrochromic device disposed on a substrate). In one example, an EC-VGU assembly includes an IGU with an inboard lite having a VGU and an outboard lite having an electrochromic laminate. In one example, an EC-VGU assembly includes an IGU with an inboard lite having a electrochromic single pane and an outboard lite having a VGU. This implementation may be desirable to protect the electrochromic device from temperature extremes in the ambient environment. In one example, an EC-VGU assembly includes an IGU with an inboard lite having a electrochromic laminate and an outboard lite having a VGU. In one example, an EC-VGU assembly includes an IGU with an inboard lite having a single pane (i.e. substrate such as, for example, a glass sheet) and an outboard lite having an EC-VGU. In one example, an EC-VGU assembly includes an IGU with an inboard lite having a EC-VGU and an outboard lite having an single pane. In one example, an EC-VGU assembly includes an IGU with an inboard lite having a laminate and an outboard lite having an EC-VGU. In one example, an EC-VGU assembly includes an IGU with an inboard lite having a EC-VGU and an outboard lite having an laminate. In one example, an EC-VGU assembly includes an IGU with an inboard lite having a first EC-VGU and an outboard lite having a second EC-VGU. With two EC-VGUs, there are two thermal barriers and this IGU provides a strong thermal barrier and highest tinting, which would be desirable for privacy tinting (e.g., 0.01% Transmissivity, 0.10×0.1). In one example, an EC-VGU assembly includes an IGU with an inboard lite having an electrochromic single pane and an outboard lite having an EC-VGU. In one example, an EC-VGU assembly includes an IGU with an inboard lite having an EC-VGU and an outboard lite having an electrochromic single pane. In one example, an EC-VGU assembly includes an IGU with an electrochromic laminate and an outboard lite having an EC-VGU. In one example, an EC-VGU assembly includes an IGU with an inboard lite having an EC-VGU and an outboard lite having an electrochromic laminate.

According to various implementations, a VGU includes an outer spacer (sometimes referred herein as an “edge spacer”) and one or more inner spacers between, and registered with, a first substrate and as second substrate to keep the two substrates from touching under vacuum. The outer spacer lies along the perimeter edge of the VGU and may be a sealing spacer. During fabrication of the VGU, a primary seal of a gasket or a primary seal material (e.g., PVB (polyvinyl butyral), PIB (polyisobutylene), or other suitable elastomer) is formed between the inner surfaces of the two substrates and the edge spacer. The edge spacer may be a metal spacer or other rigid material spacer such as a foam spacer. The one or more inner spacers may include, for example, metal, plastic, glass, ceramic and may include an adhesive to hold the inner spacers to one or both of the VGU substrates. In some cases, a desiccant may be included in a frame within which the VGU may be installed and/or in the outer spacer and/or an inner spacer during assembly to absorb any moisture and/or organic volatiles that may diffuse from the sealant materials. The VGU may be installed in, for example, a frame or a curtain wall and may be connected to a power source and/or a controller to control tint of an electrochromic device disposed on one of the substrates.

In one implementation, the bus bars are under the outer spacer and/or within the primary seal of an EC-VGU so as to keep these features from the viewable area and, e.g., to free up the secondary seal so that electrical components therein do not interfere with the aforementioned features. Some examples of IGU configurations that have these features outside of the viewable area are described in U.S. patent application, Ser. No. 13/456,056, titled “Electrochromic Window Fabrication Methods,” filed Apr. 25, 2012, which is hereby incorporated by reference in its entirety. Also, controllers that fit into the secondary seal are described in U.S. Pat. No. 8,213,074, titled “Onboard Controllers for Multistate Windows,” filed Mar. 16, 2011, which is hereby incorporated by reference in its entirety.

### Example Configurations of EC-VGUs

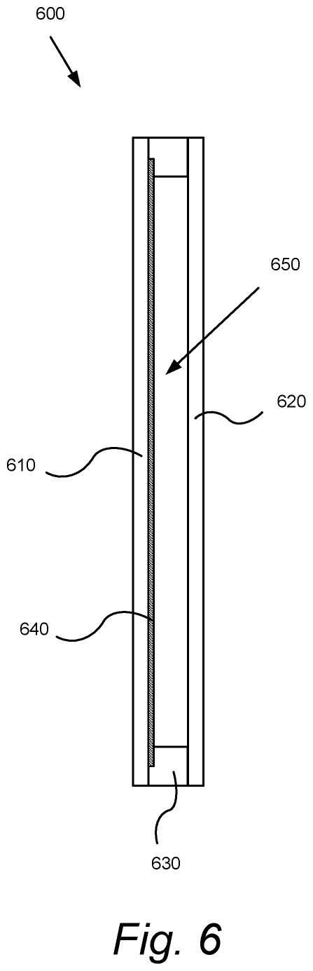

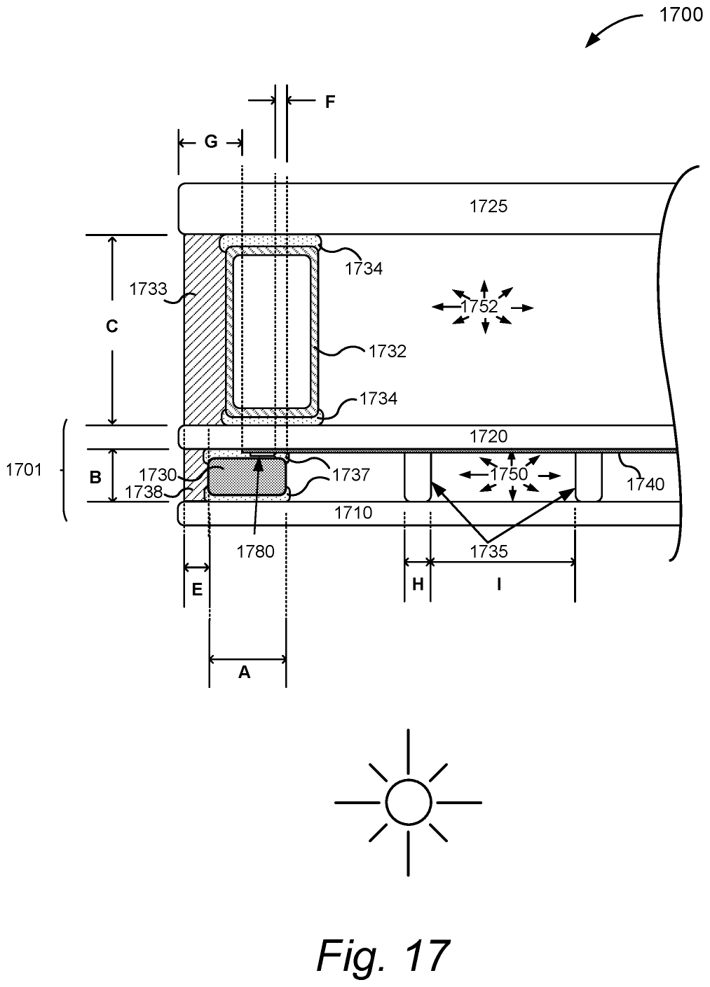

FIG. 6 depicts a schematic drawing of a cross-sectional view of an example of an EC-VGU 600 having a first substrate 610 (e.g., a glass sheet) and a second substrate 620, a spacer 630 between first substrate 610 and second substrate 620, and an electrochromic device coating 640 on an inside surface of the first substrate 610 of the EC-VGU 600, according to implementations. A primary seal material (e.g., primary seal material 1737 in FIG. 17B) is between spacer 630 and first substrate 610, between spacer 630 and second substrate 620, and between spacer 630 and a first conductor layer (e.g., a layer of tin oxide material such as fluorinated tin oxide) of the electrochromic device coating 640. The primary seal may, for example, hermetically seal an interior region 650, which is evacuated during fabrication of the EC-VGU 600 to provide a vacuum or nearly a vacuum. In this implementation, the edges of the electrochromic device coating 640 are within the primary seal of the EC-VGU 600. Bus bars may lie on the electrochromic device coating 640 within the primary seal of the EC-VGU 600. Around the perimeter of spacer 630 is a secondary seal (e.g., secondary seal material 1738 in FIG. 17B). Even though second substrate 620 in EC-VGU 600 is depicted without an electrochromic device coating, the embodiments disclosed herein are not so limited. For example, second substrate 620 may have an electrochromic device disposed thereon and/or first substrate 610 or second substrate 620 may have one or more additional coatings such as a low-E coating and the like. In addition or alternatively, first substrate 610 and/or second substrate 620 may be a laminate or may be a single substrate. Depending upon the vacuum in interior region 650, and glass thickness, inner spacers may be needed to prevent the substrates from touching and maintain a uniform spacing between them. Further depictions and associated description describe such spacers. In embodiments such as those described in relation to, e.g. FIGS. 6, 8, 10 where no inner spacers are depicted, a partial vacuum may be used, where any gas molecules remaining in the inner volume are comprised of one or more inert gases. Due to the thermal conductivity of gas molecules, it is desirable to have a strong vacuum in the inner volume of a VGU, and as such inner spacers are generally used.

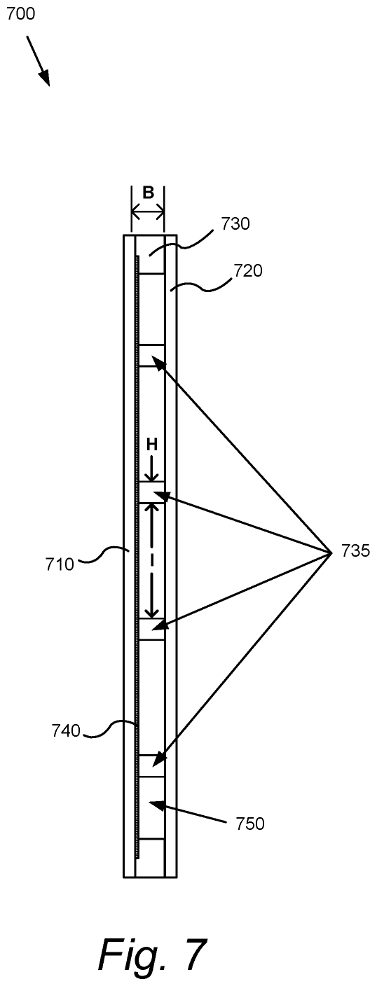

FIG. 7 depicts a schematic drawing of a cross-sectional view of an example of an EC-VGU, 700. EC-VGU 700 includes a first substrate 710 and a second substrate 720, an outer (edge) spacer 730 and four inner spacers 735 between first substrate 710 and second substrate 720, and an electrochromic device coating 740 on an inside surface of the first substrate 710 of the EC-VGU 700. The inner spacers 735 may prevent first and second substrates 710, 720 from touching due to the vacuum. In one implementation, electrochromic device coating 740 includes a protective top coat to prevent the outer spacer 730 and inner spacers 735, which may be metal, from damaging and/or shorting electrochromic device coating 740. A primary seal material (not shown) is between spacer 730 and first substrate 710, between spacer 730 and second substrate 720, and between spacer 730 and a first conductor layer (e.g., a layer of tin oxide material such as fluorinated tin oxide) of the electrochromic device coating 740. The primary seal may, for example, hermetically seal an interior region 750, which is evacuated during fabrication of the EC-VGU 700 to provide a vacuum or nearly a vacuum. In this implementation, the edges of the electrochromic device coating 740 are within the primary seal of the EC-VGU 700. Bus bars may lie on the electrochromic device coating 740 within the primary seal of the EC-VGU 700. Around the perimeter of spacer 730 is a secondary seal (not shown). Even though second substrate 720 in EC-VGU 700 is depicted without an electrochromic device coating, the embodiments disclosed herein are not so limited. For example, second substrate 720 may have an electrochromic device disposed thereon and/or first substrate 710 or second substrate 720 may have one or more additional coatings such as a low-E coating and the like. In addition or alternatively, first substrate 710 and/or second substrate 720 may be a laminate. Although four inner spacers 735 are shown, fewer or additional inner spacers 735 may be used.

FIG. 7 also depicts a spacing “I” between the inner spacers 735 and a width “H” of the inner spacers 735, and a distance “B” between the first substrate 710 and a second substrate 720. The spacing, I, between inner spacers is preferably maximized so as to have minimal impact on the visual aesthetics of the window constructed from the EC-VGU. The width, H, of the inner spacers preferably is minimized for the same reason, although since the substrates are pressing on the spacers, it is also preferable to ensure sufficient surface area of the faces of the spacer touching the substrates so as to minimize pressure on the substrates. Distance, B, is preferably minimized so as to enable thinner constructs for buildings, e.g. having superior thermal insulative properties than a conventional triple pane IGU and a thinner cross-section (as many triple pane IGU's are cumbersome for glaziers to incorporate into framing systems). The thickness of the substrates used in the VGU may vary depending upon the inner spacers used. Generally, the vacuum needs to be strong, as any remaining gas molecules in the evacuated space are efficient thermal conductors. In one embodiment, the vacuum is formed after flushing/filling the interior region with argon or other inert gas. In that way, any remaining molecules after evacuation, have some thermal insulative properties over air. In some embodiments, the inert gas in an EC-VGU, whether in a partially evacuated volume or an inert gas filled volume, is krypton. In one embodiment, the interior region is evacuated, filled with the inert gas, and the process repeated one or more times to ensure that any air is removed and any outgassed molecules from the glass, spacers or adhesives are removed from the interior region.

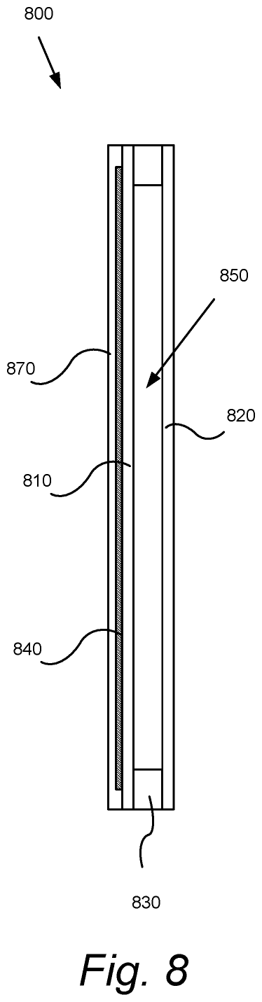

FIG. 8 depicts a schematic drawing of a cross-sectional view of an example of an EC-VGU 800 having a first substrate 810 and a second substrate 820, a spacer 830 between first substrate 810 and second substrate 820, and an electrochromic device coating 830 on an outside surface of the first substrate 810 of the EC-VGU 800, according to implementations. EC-VGU 800 includes a layer 870 that may be a mate lite (e.g., a thin flexible substrate) laminated to first substrate 810 with a lamination adhesive (not shown) to form a laminate. Alternatively, layer 870 may be a protective coating, such as a hermetic coating, to protect the electrochromic device coating 830 from the environment. A primary seal material (not shown) is between spacer 830 and first substrate 810 and between spacer 830 and second substrate 820. Primary seal may, for example, hermetically seal an interior region 850, which is evacuated during fabrication of the EC-VGU 800 to provide a vacuum or nearly a vacuum. In this implementation, the electrochromic device coating 830 is between the layer 870 and the first substrate 810. Bus bars may lie on the electrochromic device coating 830 within the lamination adhesive. Around the perimeter of spacer 830 is a secondary seal (not shown). Even though second substrate 820 in EC-VGU 800 is depicted without an electrochromic device coating, the embodiments disclosed herein are not so limited. For example, second substrate 820 may have an electrochromic device disposed thereon and/or second substrate 820 may have one or more additional coatings such as a low-E coating and the like. In addition or alternatively, second substrate 820 may be in laminate form including multiple substrate layers.

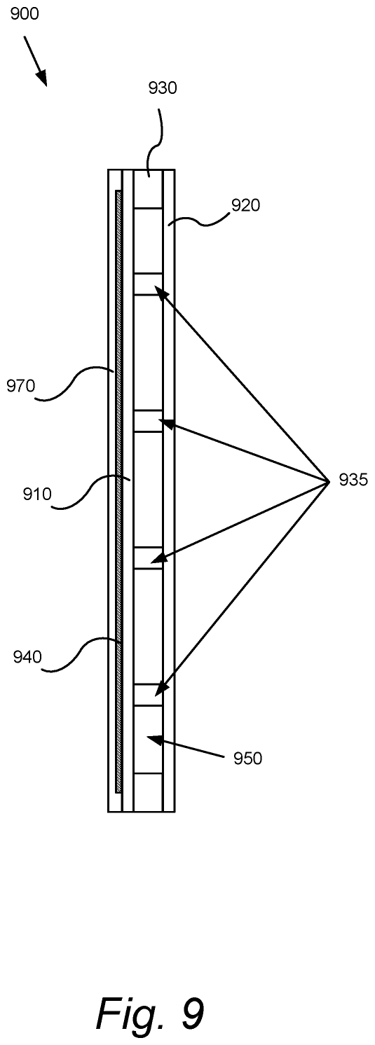

FIG. 9 depicts a schematic drawing of a cross-sectional view of an example of an EC-VGU 900, e.g., EC-VGU 800 described in relation to FIG. 8, according to implementations. EC-VGU 900 includes a first substrate 910 and a second substrate 920, an outer (edge) spacer 930 and four inner spacers 935 between first substrate 910 and second substrate 920, and an electrochromic device coating 930 on an outside surface of the first substrate 910 of the EC-VGU 900. The inner spacers 935 may prevent first and second substrates 910, 920 from touching due to the vacuum. EC-VGU 900 also includes a layer 970 that may be a mate lite laminated to first substrate 910 with a lamination adhesive (not shown) to form a laminate. Alternatively, layer 970 may be a protective coating, such as a hermetic coating, to protect the electrochromic device coating 930 from the environment. A primary seal material (not shown) is between spacer 930 and first substrate 910 and between spacer 930 and second substrate 920. The primary seal may, for example, hermetically seal an interior region 950, which is evacuated during fabrication of the EC-VGU 900 to provide a vacuum or nearly a vacuum. In this implementation, the electrochromic device coating 930 is between the layer 970 and the first substrate 910. Bus bars may lie on the electrochromic device coating 930 within the lamination adhesive. Around the perimeter of spacer 930 is a secondary seal (not shown). Even though second substrate 920 in EC-VGU 900 is depicted without an electrochromic device coating, the embodiments disclosed herein are not so limited. For example, second substrate 920 may have an electrochromic device disposed thereon and/or second substrate 920 may have one or more additional coatings such as a low-E coating and the like. In addition or alternatively, second lite 920 may be in laminate form including multiple substrate layers. Although four inner spacers 935 are shown, fewer or additional inner spacers 935 may be used.

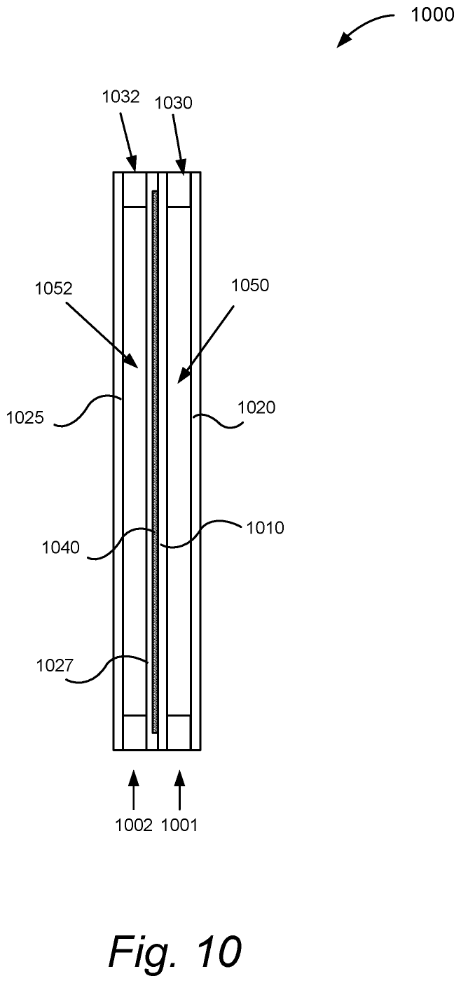

FIG. 10 depicts a schematic drawing of a cross-sectional view of an example of an EC-VGU 1000 including a first VGU 1001 with a first substrate 1010 and a second substrate 1020 and a second VGU 1002 with a third substrate 1025 and a fourth substrate 1027, according to implementations. EC-VGU 1000 also includes a first spacer 1030 between first substrate 1010 and second substrate 1020 and a second spacer 1032 between third substrate 1025 and fourth substrate 1027. EC-VGU 1000 also includes an electrochromic device coating 1040 between the first substrate 1010 and the fourth substrate 1027. In one implementation, each of the two VGUs is coated with, or has, a conductive material such as transparent conductive oxide (TCO) on an exterior surface. Next, a cathode (an electrochromic layer or a counter electrode layer) is coated on one of the VGUs and an anode (the other of the electrochromic layer or a counter electrode layer) is coated on the other one of the VGUs. The two VGU electrodes (cathode and anode) are sandwiched together with an ion conductive lamination adhesive to form the EC-VGU 1000. In another implementation, the EC-VGU 1000 may be formed using a pre-formed electrochromic laminate (e.g., including first substrate 1010, electrochromic device coating 1040, and fourth substrate 1027) and forming the first and second VGUs on either side of the laminate. EC-VGU 1000 also includes a first interior space 1050 and a second interior space 1052. In one implementation, one of the first interior space 1050 and the second interior space 1052 is evacuated to be at vacuum and the other one is filled with an inert gas. In another implementation, both first interior space 1050 and the second interior space 1052 are evacuated. A primary seal material (not shown) is between spacer 1030 and first substrate 1010, between spacer 1030 and second substrate 1020, between spacer 1032 and third substrate 1025, and between spacer 1032 and second substrate 1027. The primary seal may, for example, hermetically seal first interior region 1050 and second interior region 1052. Around the perimeter of spacers 1030, 1032 is a secondary seal (not shown). Even though second substrate 1020 and third substrate 1025 in EC-VGU 1000 are depicted without an electrochromic device coating, the embodiments disclosed herein are not so limited. For example, second substrate 1020 and/or third substrate 1025 may have an electrochromic device disposed thereon and/or second substrate 1020 and/or third substrate 1025 may have one or more additional coatings such as a low-E coating and the like.

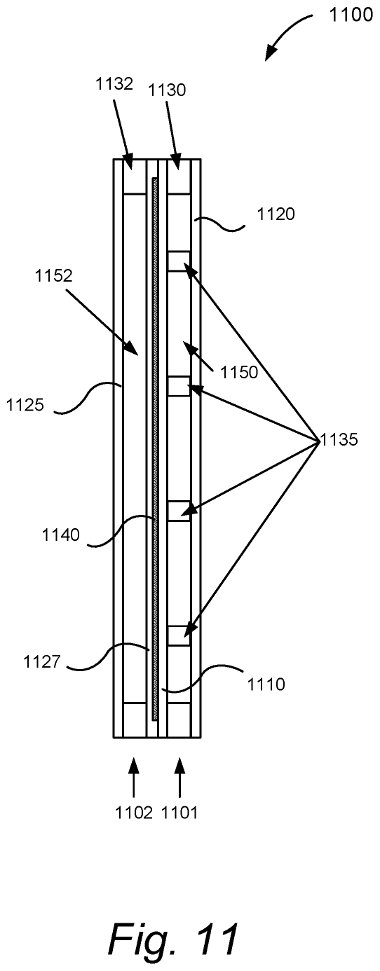

FIG. 11 depicts a schematic drawing of a cross-sectional view of an example of an EC-VGU 1100, e.g., EC-VGU 1000 described in relation to FIG. 10, according to implementations. EC-VGU 1100 includes a first VGU 1101 with a first substrate 1110 and a second substrate 1120 and a second VGU 1102 with a third substrate 1125 and a fourth substrate 1127, according to implementations. EC-VGU 1100 also includes a first spacer 1130 between first substrate 1111 and second substrate 1120, a second spacer 1132 between third substrate 1125 and fourth substrate 1127, and one or more inner spacers 1135 between first substrate 1110 and second substrate 1120. EC-VGU 1100 also includes an electrochromic device coating 1140 between the first substrate 1110 and the fourth substrate 1127. EC-VGU 1100 also includes a first interior space 1150 and a second interior space 1152. A primary seal material (not shown) is between spacer 1130 and first substrate 1110, between spacer 1130 and second substrate 1120, between spacer 1132 and third substrate 1125, and between spacer 1132 and second substrate 1127. The primary seal may, for example, hermetically seal first interior region 1150 and second interior region 1152. Around the perimeter of first spacer 1130 and second spacer 1132 is a secondary seal (not shown). In this example, the first interior space 1150 is evacuated and second interior space 1152 is filled with an inert gas. In another implementation, the second interior space 1152 may also be evacuated. In this case, the EC-VGU 1100 also includes one or more inner spacers between the third substrate 1125 and fourth substrate 1127 to prevent the substrates from touching under vacuum. In yet another implementation, the second interior space 1152 may be evacuated and the first interior space 1150 filled with inert gas. Even though second substrate 1120 and third substrate 1125 in EC-VGU 1100 are depicted without an electrochromic device coating, the embodiments disclosed herein are not so limited. For example, second substrate 1120 and/or third substrate 1125 may have an electrochromic device disposed thereon and/or second substrate 1120 and/or third substrate 1125 may have one or more additional coatings such as a low-E coating and the like. In addition or alternatively, second substrate 1120 and/or third substrate 1125 may be in laminate form including multiple substrate layers.

Any examples of EC-VGUs described herein can be a mate lite of an IGU. Some examples are described in the following section. The suggested orientation of the constructs with respect to the solar exposure is also depicted (using a representation of the sun). More detailed aspects of EC-VGUs are described below.

FIG. 12 is a schematic drawing depicting a cross-sectional view of an example of an EC-VGU assembly 1200 including an insulated glass unit having an inboard lite including a VGU 1201 with a first substrate 1210 and a second substrate 1220, a third substrate 1225, and a spacer 1232 between VGU 1201 and third substrate 1225, according to implementations. VGU 1201 also includes an edge spacer 1230 and one or more inner spacers (e.g., inner spacers 1235 shown in FIG. 13), between first substrate 1210 and second substrate 1220. In addition, VGU 1201 includes a first interior region 1250 between edge spacer 1230 and one or more inner spacers (e.g., inner spacers 1335 shown in FIG. 13) and the interior-facing surfaces of first substrate 1210 and second substrate 1220. The first interior region 1250 is evacuated. EC-VGU assembly 1200 also includes a second interior region 1252 between spacer 1232 and the interior facing surfaces of first substrate 1210 and third substrate 1225. The second interior region 1252 is filled with an inert gas such as, e.g., argon. Third substrate 1225 includes an electrochromic device coating 1240 disposed on an interior-facing surface. Third substrate 1225 may be a glass sheet (e.g., a tempered glass sheet).

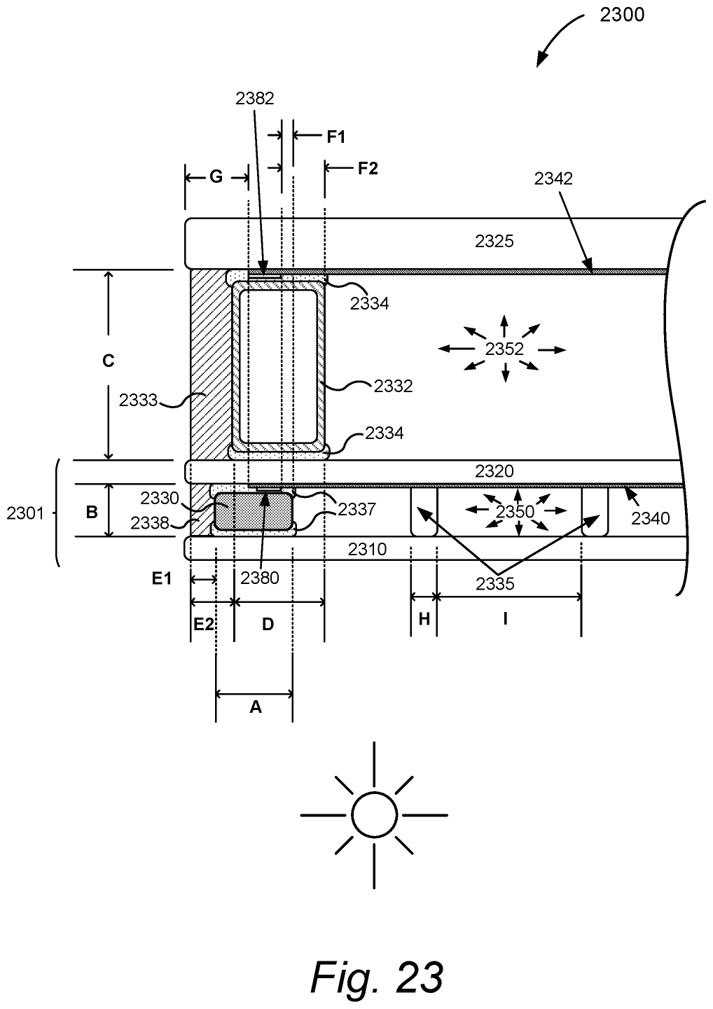

FIG. 13 is a partial cross section of an EC-VGU assembly 1300 including an insulated glass unit having an inboard lite and an outboard lite substantially parallel to each other, according to implementations. The illustrated example shows a portion of the insulated glass unit near to and including an edge of the insulated glass unit. EC-VGU assembly 1200 in FIG. 12 and EC-VGU assembly 1300 in FIG. 13 have similar configurations and may have similar components. The inboard lite includes a VGU 1301 having a first substrate 1310, a second substrate 1320, an edge spacer 1332, and one or more inner spacers 1335 between first substrate 1310 and second substrate 1320. The outboard lite includes a third substrate 1325 (e.g., a tempered glass sheet) with an electrochromic device coating 1340 disposed on an interior-facing surface. The electrochromic device coating may be on the order of less than one micron thick to a few microns thick. A primary seal material (e.g., primary seal material 2337 in FIG. 23), e.g., PIB or other like adhesive sealant, is between spacer 1330 and first substrate 1310 and between spacer 1330 and second substrate 1320 of the VGU 1301. The primary seal material may hermetically seal the interior region 1350, which is evacuated. Around the primary seal of the VGU 1301 and between first substrate 1310 and second substrate 1320 is a sealant (e.g., secondary seal material 2338 in FIG. 23), which forms the secondary seal of the VGU 1301. Also, a primary seal material 1334 is between spacer 1332 and first substrate 1310 and between spacer 1332 and third substrate 1325. Primary seal material 1334 serves to hermetically seal the interior region 1352 from the ambient. The interior region 1352 is charged with an inert gas such as argon. Around the perimeter of the primary seal and between and first substrate 1310 and third substrate 1325 is a sealant, 1333, which forms the secondary seal of the IGU. On electrochromic device coating 1340, between second spacer 1332 and the third substrate 1325 is a bus bar 1380. Bus bar 1380 may be on the first conductive layer or the second conductive layer of the electrochromic device coating 1340. Bus bar 1380 may be between about 1 mm and about 5 mm wide, typically about 3 mm wide. In one implementation, spacer 1332 may be a metal spacer. In this case, second spacer 1332 may be coated with an insulating material at least on the side proximate bus bar 1380 or an insulating material may be applied to the bus bar 1380 so as to avoid inadvertent electrical shorting between the second spacer 1332 and the bus bar 1380. Alternatively, spacer 1332 and/or spacer 1330 may be a polymeric spacer.

In an alternative embodiment, the example of the EC-VGU assembly 1200 illustrated in FIGS. 12 and 13 may be oriented in the opposite direction. In this alternative embodiment, the EC-VGU assembly 1200 includes an outboard lite with VGU 1201 having first substrate 1210 and second substrate 1220, third substrate 1225 inboard of the outboard lite, and a spacer 1232 between VGU 1201 and third substrate 1225. In this alternative embodiment, the electrochromic device coating 1240 is more inboard than in the illustrated example, which may be advantageous in protecting the electrochromic device coating 1240 from temperature extremes from the external environment. The dimensions, A, B, C, D, E, F, G, H, and I define a number of configurational aspects of embodiments of EC-VGU assemblies. One such embodiment is an EC-VGU assembly having at least one of the dimensions A, B, C, D, E, F, G, H, and I as described below. In one embodiment, an EC-VGU assembly has a configuration that includes all of the dimensions A, B, C, D, E, F, G, H, and I such as shown in FIG. 13. Further Figures use these reference symbols in an analogous fashion in order to describe exemplary embodiments of EC-VGUs.

The dimension, A, defines the width of the edge spacer of a VGU and the dimension, B, defines the height of the edge spacer of the VGU. Dimension B also is a measure of the height of the primary seal and secondary seal of the VGU.

The dimension, C, defines the distance between the interior-facing surfaces of the inboard and outboard lites of the IGU construct of the EC-VGU assembly. Dimension Cis between about 6 mm and about 30 mm, between about 10 mm and about 20 mm, or between about 12 mm and about 13 mm. Dimension C also is a measure of the height of the primary seal and secondary seal of the IGU. The length of the primary seal and secondary seals will depend on the size of the IGU, as these seals each span a perimeter inside the perimeter of the lites of the IGU.

The width of the primary seal of the IGU approximates, within ±2 mm, the width, D, of the spacer of the IGU, with some variation due to the primary sealant squeezing out between the spacer and the glass during IGU fabrication (the negative variation is due to some sealant not expanding to the width of the spacer). In one embodiment, the width of the spacer is between about 5 mm and about 15 mm. In another embodiment, the width of the spacer is between about 5 mm and about 10 mm, in another embodiment between about 7 mm and 8 mm.

The distance, E, defines the width of the secondary seal of the VGU. In one embodiment, the secondary seal of the IGU and/or the VGU is between about 2 mm and about 15 mm wide, in another embodiment between about 3 mm and about 10 mm wide, and in yet another embodiment between about 4 mm and about 8 mm wide. The width of the secondary seal may be set independently of the other dimensions described in relation to FIG. 12B, or, e.g., may be set as an artifact of the choice for dimensions D, F and G. Dimensions F and G are described below.

The distance, F, is the backset, which is the distance between the inner edge of the spacer and the inner edge of a bus bar or a scribe. The backset is a measure of how far “back” a bus bar or scribe is positioned from the inner edge of the spacer, so as to obscure the bus bar and/or scribe from the viewable area of the EC coating. In one embodiment, the backset is between about 1 mm and about 5 mm, in another embodiment, between about 2 mm and about 3 mm, in yet another embodiment about 2 mm. The backset may vary from one side of the IGU to another, as in the described embodiments, the spacer is configured to obscure these features, and these features need not be symmetrically dimensioned with respect to the spacer, the spacer need only obscure them. In other words the backset for a given feature, a scribe line or a bus bar may be different on one side of the IGU as compared to another side of the IGU. FIG. 13 shows that the edge of EC device coating 1240 is protected by the primary seal 1334. The backset allows any bus bar or scribe line to be obscured and ensures the edge of the EC device is protected by the primary seal 1334.

In one embodiment, the primary seal is a two-part seal. For example, the portion of the primary seal that protects the edge of the EC device is a polymeric adhesive seal as depicted, while the outer portion, nearer the outer side of the spacer, where the spacer is over the edge delete area, the seal is a diffusion bonding type seal, where the metal spacer and glass are diffusion bonded on that portion of the spacer.

The distance, G, is a measure of the edge delete. This is the width of the perimeter portion of the EC device removed to expose the glass and/or the diffusion barrier. As described above, in one embodiment, the perimeter portion is between about 1 mm and about 20 mm wide, in another embodiment between about 5 mm and about 15 mm wide, and in yet another embodiment between about 8 mm and about 10 mm wide. In one embodiment the glass is exposed, that is, the EC device and any diffusion barrier are removed in the edge delete. In one embodiment, the edge delete is performed so as to also remove between about 0.5 micrometers (μm) and about 3 μm of the glass substrate, e.g. to ensure complete removal of the EC device and diffusion barrier (accounting for variation in thickness and planarity of the substrate). In one embodiment, the edge delete is performed so as to also remove between about 1 μm and about 2 μm of the glass substrate. In another embodiment, the edge delete is performed so as to also remove about 1.5 μm of the glass substrate.

The dimension, H, defines the width of at least one of the inner spacers of a VGU and dimension, I, defines the distance between at least two adjacent inner spacers of the VGU.

FIG. 14 depicts a schematic drawing of a cross-sectional view of an example of an EC-VGU assembly 1400 including an insulated glass unit having an inboard lite that includes a VGU 1401 with a first substrate 1410 and a second substrate 1420, an outboard lite that includes a laminate 1402, and a spacer 1432 between VGU 1401 and laminate 1402, according to implementations. The laminate 1402 includes a third substrate 1425 and a fourth substrate 1427 laminated together with a lamination adhesive. The laminate 1402 also includes an electrochromic device coating 1440 disposed between third substrate 1425 and fourth substrate 1427. VGU 1401 also includes an edge spacer 1430 and one or more inner spacers (e.g., inner spacers 1535 shown in FIG. 15) between first substrate 1410 and second substrate 1420. VGU 1401 also includes a first interior region 1450 between edge spacer 1430 and one or more inner spacers (e.g., inner spacers 1535 shown in FIG. 15) and the interior-facing surfaces of first substrate 1410 and second substrate 1420. The first interior region 1450 is evacuated. EC-VGU assembly 1400 also includes a second interior region 1452 between second spacer 1432 and interior-facing surfaces of first substrate 1410 and fourth substrate 1427. The second interior region 1452 is filled with an inert gas such as argon.

FIG. 15 is a partial cross section of the EC-VGU assembly 1500 including an insulated glass unit having an inboard lite and an outboard lite substantially parallel to each other, according to implementations. The illustrated example shows a portion of the insulated glass unit near to and including an edge of the insulated glass unit, according to implementations. EC-VGU assembly 1400 in FIG. 14 and EC-VGU assembly 1500 in FIG. 15 are similar configurations and may have similar components. The inboard lite includes a VGU 1501 having a first substrate 1510, a second substrate 1520, and an edge spacer 1530 and one or more inner spacers 1535 between first substrate 1510 and second substrate 1520. The outboard lite includes a laminate 1502 having a third substrate 1525, a fourth substrate 1527, and an electrochromic device coating 1540 disposed between third substrate 1525 and fourth substrate 1527. The electrochromic device coating 1540 may be on the order of less than one micron thick to a few microns thick. A primary seal material (e.g., primary seal material 2337 in FIG. 23), e.g., PIB or other like adhesive sealant, is between spacer 1530 and first substrate 1510 and between spacer 1530 and second substrate 1520 of the VGU 1501. The primary seal material may hermetically seal the interior region 1550, which is evacuated. Around the primary seal of the VGU 1501 and between first substrate 1510 and second substrate 1520 is a sealant (e.g., secondary seal material 1738 in FIG. 17B), which forms the secondary seal of the VGU 1501. A primary seal material 1534 is between spacer 1532 and first substrate 1510 and between spacer 1532 and fourth substrate 1527. Primary seal material 1534 serves to hermetically seal the interior region 1552 from the ambient. The interior region 1552 is charged with an inert gas such as argon. Around the perimeter of the primary seal of the IGU and between first substrate 1510 and fourth substrate 1527 is a sealant 1533, which forms the secondary seal of the IGU. The EC-VGU assembly 1500 also includes a bus bar 1580 disposed on electrochromic device coating 1540 between the third substrate 1525 and fourth substrate 1527 of the laminate 1502. Bus bar 1580 may be on the first conductive layer or the second conductive layer of the electrochromic device coating 1540. Bus bar 1580 may be between about 1 mm and about 5 mm wide, typically about 3 mm wide. In one implementation, spacer 1532 and/or spacer 1530 may be metal spacers. In another implementation, spacer 1532 and/or spacer 1530 may be polymeric spacers.

In an alternative embodiment, the example of the EC-VGU assembly 1400 illustrated in FIG. 14 may be oriented in the opposite direction. In this alternative embodiment, the EC-VGU assembly 1400 includes an outboard lite with VGU 1401 having the first substrate 1410 and the second substrate 1420, an inboard lite with laminate 1402, and the spacer 1432 between VGU 1401 and laminate 1402. In this alternative embodiment, the electrochromic device coating 1440 is more inboard than in the illustrated example, which may be advantageous in protecting the electrochromic device coating 1540 from temperature extremes from the external environment. In an alternative embodiment, the example of EC-VGU assembly 1500 illustrated in FIG. 15 may be oriented in the opposite direction. In this alternative embodiment, the EC-VGU assembly 1500 includes an outboard lite with VGU 1501 having first substrate 1510 and the second substrate 1520, an inboard lite with laminate 1502, and the spacer 1532 between VGU 1501 and laminate 1502. In this alternative embodiment, the electrochromic device coating 1540 is more inboard than in the illustrated example, which may be advantageous in protecting the electrochromic device coating 1540 from temperature extremes from the external environment.

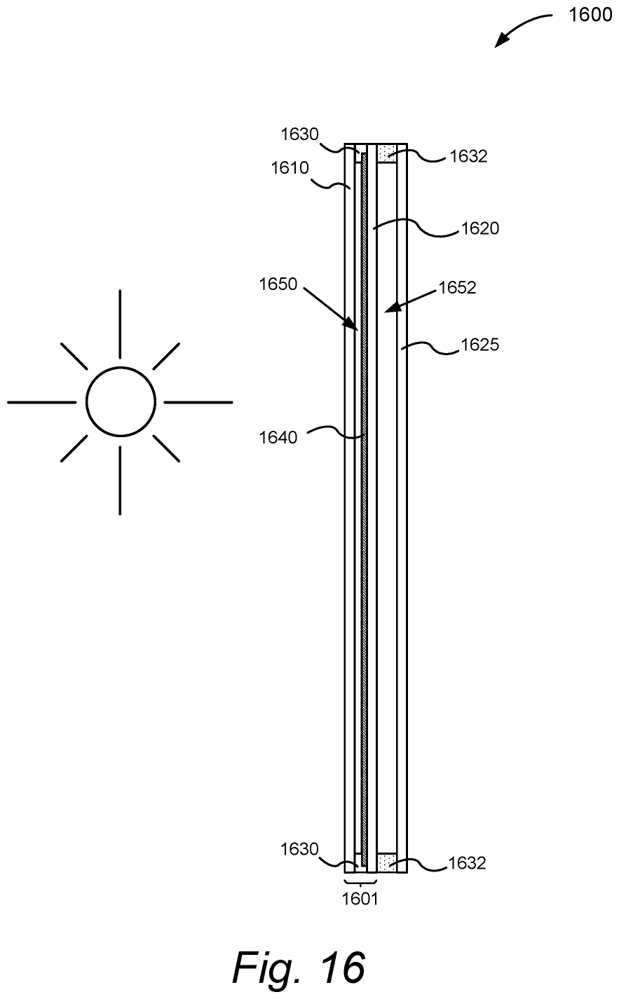

FIG. 16 depicts a schematic drawing of a cross-sectional view of an example of an EC-VGU assembly 1600 including an insulated glass unit having an inboard lite that is a VGU 1601 with a first substrate 1610 (e.g., a tempered glass sheet) and a second substrate 1620, and an electrochromic device coating 1640 disposed on an interior-facing surface of the second substrate 1620 of the VGU 1601, according to implementations. The insulated glass unit also includes an outboard lite having an third substrate 1625 outboard of the inboard lite, and a spacer 1632 between the VGU 1601 and the third substrate 1625. VGU 1601 also includes an edge spacer 1632 and one or more inner spacers (e.g., inner spacers 1735 shown in FIG. 17) between first substrate 1610 and second substrate 1620. VGU 1601 also includes a first interior region 1650 between edge spacer 1630, one or more inner spacers (e.g., inner spacers 1735 shown in FIG. 17) and the interior-facing surfaces of first substrate 1610 and second substrate 1620. The first interior region 1650 is evacuated. EC-VGU assembly 1600 also includes a second interior region 1652 between spacer 1632 and second substrate 1620 and third substrate 1625. The second interior region 1652 is filled with an inert gas such as argon.

FIG. 17 is a partial cross section of the EC-VGU assembly 1700 including an insulated glass unit having an inboard lite and an outboard lite substantially parallel to each other, according to implementations. The illustrated example shows a portion of the insulated glass unit near to and including an edge of the insulated glass unit. EC-VGU assembly 1600 in FIG. 16 and EC-VGU assembly 1700 in FIG. 17 have similar configurations and may have similar components. The outboard lite includes a VGU 1701 having a first substrate 1710, a second substrate 1720, and an edge spacer 1730 and one or more inner spacers 1735 between first substrate 1710 and second substrate 1720. VGU 1701 also includes an electrochromic device coating 1740 disposed on an exterior-facing surface of the second substrate 1720. The electrochromic device coating 1740 may be on the order of less than one micron thick to a few microns thick. A primary seal material 1737, e.g., PIB or other like adhesive sealant, is between first spacer 1730 and first substrate 1710 and between spacer 1730 and second substrate 1720 of the VGU 1701. The primary seal material 1737 may hermetically seal the interior region 1750, which is evacuated. Around the primary seal of the VGU 1701 and between first substrate 1710 and second substrate 1720 is a secondary seal material 1738, which forms the secondary seal of the VGU 1701. A primary seal material 1734 is between spacer 1732 and second substrate 1720 and between spacer 1732 and third substrate 1725. Primary seal material 1734 serves to hermetically seal the interior region 1752 from the ambient. The interior region 1752 is charged with an inert gas such as argon. Around the perimeter of the primary seal and between and second substrate 1720 and third substrate 1725 is a sealant 1733, which forms the secondary seal of the IGU. In this example, the edges of the electrochromic device coating 1740 are within the primary seal material 1737 of the VGU 1701. One or more bus bars may lie on the electrochromic device coating 1740 within the primary seal 1737. In this example, a bus bar 1780 is disposed on electrochromic device coating 1740, between first spacer 1730 and the second substrate 1720, and within primary seal material 1737. Bus bar 1780 may be disposed on the first conductive layer or the second conductive layer of the electrochromic device coating 1740. Bus bar 1780 may be between about 1 mm and about 5 mm wide, typically about 3 mm wide. In one implementation, first spacer 1730 may be a metal spacer. In this case, spacer 1730 may be coated with an insulating material at least on the side proximate bus bar 1780 or an insulating material may be applied to bus bar 1780 to avoid inadvertent electrical shorting between the spacer 1730 and bus bar 1780. Alternatively, first spacer 1730 and/or second spacer 1732 may be a polymeric spacer.

In alternative embodiments, the examples of the EC-VGU assembly 1600 in FIG. 16 and EC-VGU assembly 1500 in FIG. 15 may be oriented in the opposite direction. In the alternative embodiments, EC-VGU assembly 1600 includes an outboard lite with the VGU 1601 having the first substrate 1610 and second substrate 1620, a third substrate 1625 inboard of the outboard lite, and spacer 1632 between the VGU 1601 and third substrate 1625 and/or EC-VGU assembly 1500 includes an outboard lite with VGU 1501 having the first substrate 1510 and second substrate 1520, a third substrate 1525 inboard of the outboard lite, and spacer 1532 between the VGU 1501 and third substrate 1525.

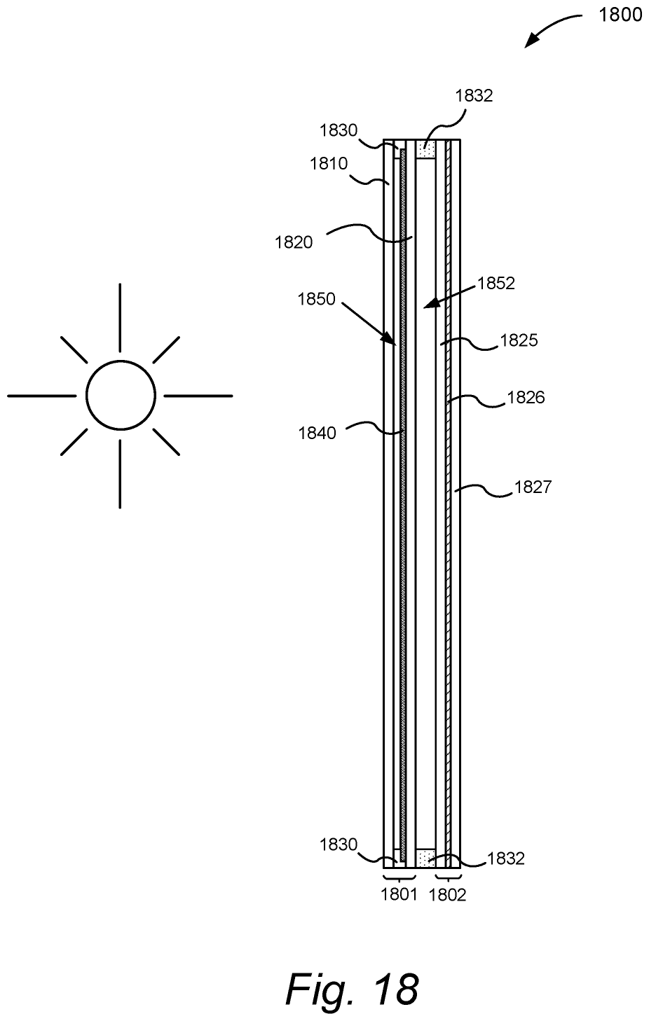

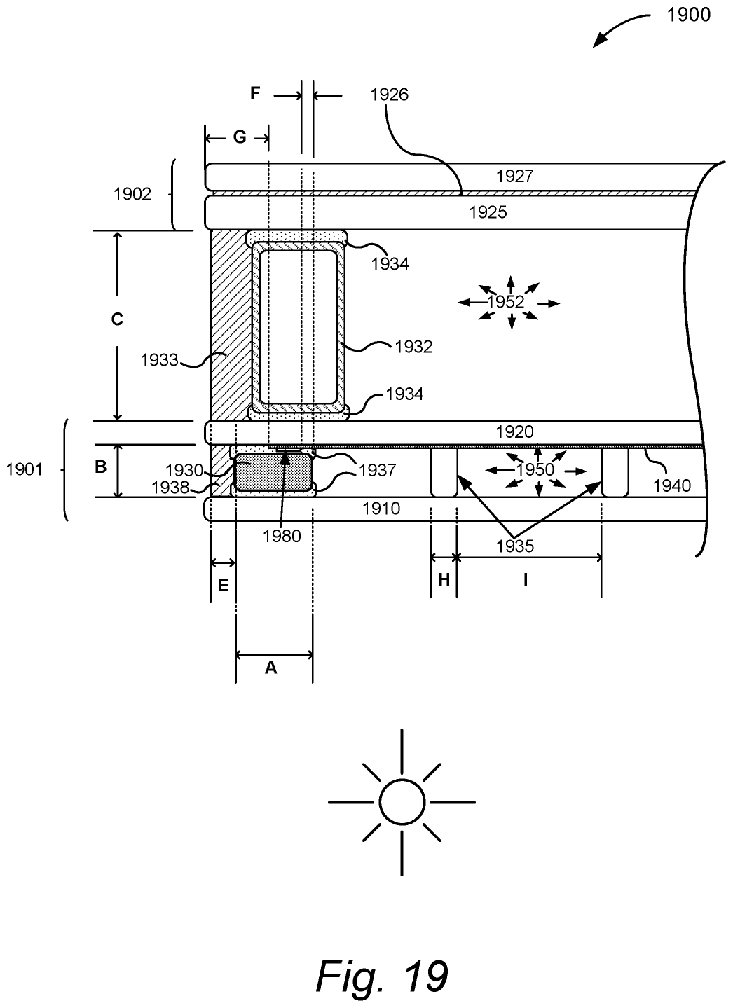

FIG. 18 depicts a schematic drawing of a cross-sectional view of an example of an EC-VGU assembly 1800 including an insulated glass unit having an outboard lite including an VGU 1801, an inboard lite having a laminate 1802, and a spacer 1832 between VGU 1801 and laminate 1802, according to implementations. VGU 1801 includes a first substrate 1810 (e.g., a tempered glass sheet), a second substrate 1820, and an edge spacer 1830 and one or more inner spacers (e.g., inner spacers 1935 shown in FIG. 19) between first substrate 1810 and second substrate 1820. Laminate 1802 includes a third substrate 1825, a fourth substrate 1827, and a lamination adhesive 1826 therebetween. VGU assembly 1800 also includes an electrochromic device coating 1840 disposed on an exterior-facing surface of the second substrate 1820 of the VGU 1801. VGU 1801 includes a first interior region 1850 between edge spacer 1832, the inner spacers and the interior-facing surfaces of first substrate 1810 and second substrate 1820. The first interior region 1850 is evacuated. EC-VGU assembly 1800 also includes a second interior region 1852 between second spacer 1832 and interior-facing surfaces of the second substrate 1820 and third substrate 1825. The second interior region 1852 is filled with an inert gas such as argon.

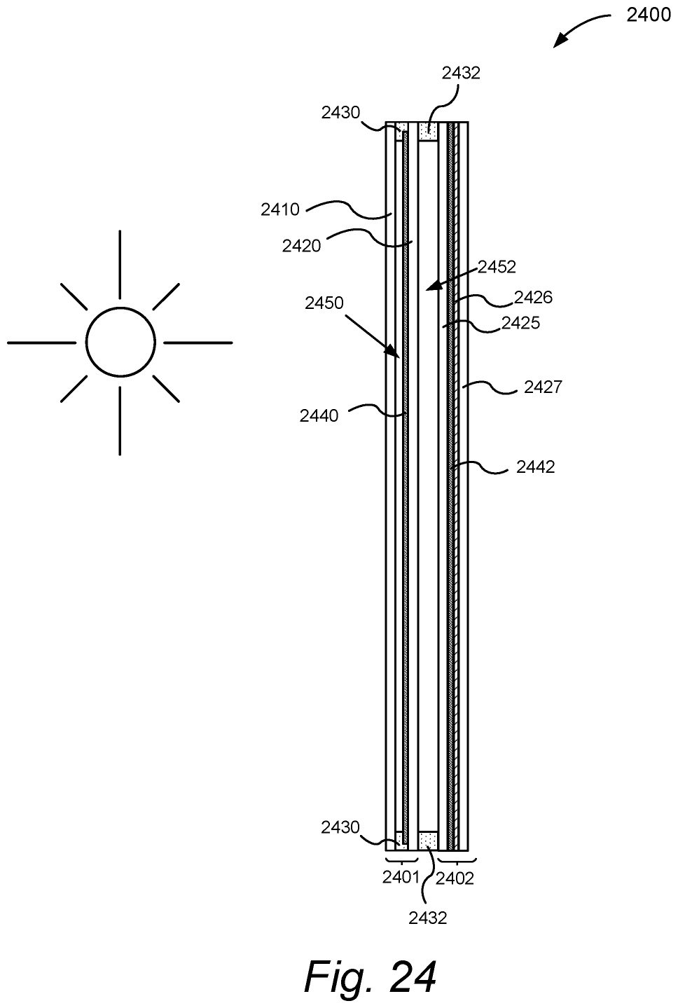

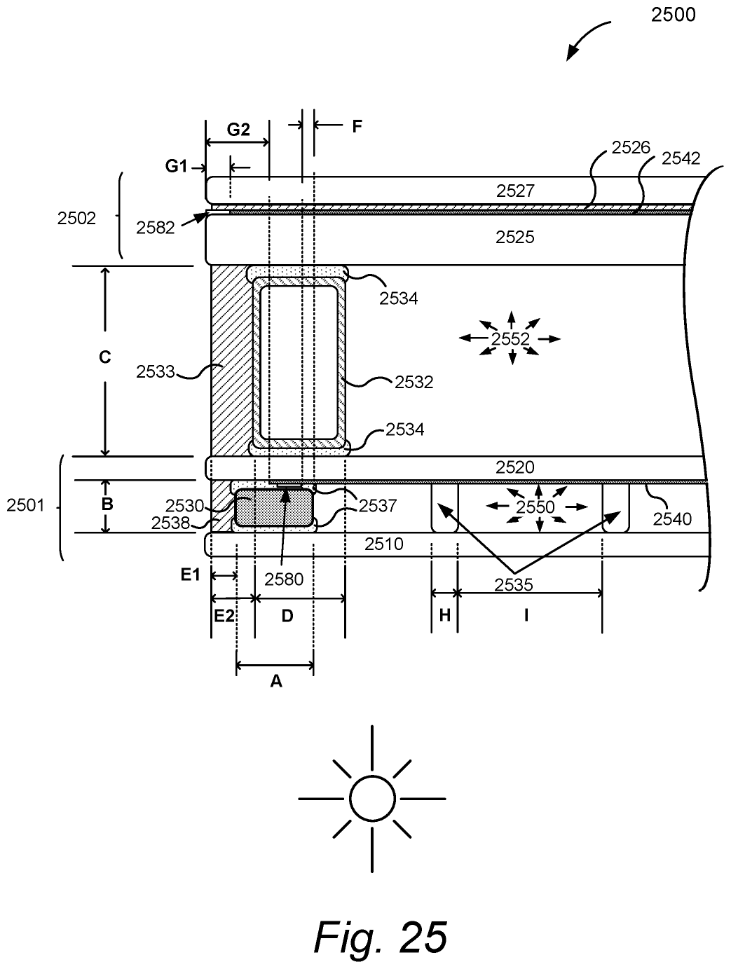

FIG. 19 is a partial cross section of the EC-VGU assembly 1900 including an insulated glass unit having an inboard lite and an outboard lite substantially parallel to each other, according to implementations. The illustrated example shows a portion of the insulated glass unit near to and including an edge of the insulated glass unit. EC-VGU assembly 2500 in FIG. 25 and EC-VGU assembly 2400 in FIG. 24 have similar configurations and may have similar components. The outboard lite includes a VGU 1901 having a first substrate 1910, a second substrate 1920, and an edge spacer 1930 and one or more inner spacers 1935 between first substrate 1910 and second substrate 1920. VGU 1901 also includes an electrochromic device coating 1940 disposed on an exterior-facing surface of second substrate 1920. The electrochromic device coating may be on the order of less than one micron thick to a few microns thick. A primary seal material 1937, e.g., PIB or other like adhesive sealant, is between spacer 1930 and first substrate 1910 and between first spacer 1930 and second substrate 1920 of the VGU 1901. The primary seal material 1937 may hermetically seal the interior region 1950, which is evacuated. Around the primary seal of the VGU 1901 and between first substrate 1910 and second substrate 1920 is a secondary seal material 1938, which forms the secondary seal of the VGU 1901. A primary seal material 1934 is between spacer 1932 and second substrate 1920 and between spacer 1932 and third substrate 1925. Primary seal material 1934 serves to hermetically seal the interior region 1952 from the ambient. The interior region 1952 is charged with an inert gas such as argon. Around the perimeter of the primary seal and between and second substrate 1920 and third substrate 1925 is a sealant 1933, which forms the secondary seal of the IGU. In this example, the edges of the electrochromic device coating 1940 are within the primary seal material 1937 of the VGU 1901. One or more bus bars may lie on the electrochromic device coating 1940 within the primary seal 1937 of the EC-VGU 1900. In this illustrated example, a bus bar 1980 is disposed on electrochromic device coating 1940 between spacer 1930 and second substrate 1920, and within primary seal material 1937. Bus bar 1980 may be disposed on the first conductive layer or the second conductive layer of the electrochromic device coating 1940. Bus bar 1980 may be between about 1 mm and about 5 mm wide, typically about 3 mm wide. In one implementation, spacer 1930 may be a metal spacer. In this case, first spacer 1930 may be coated with an insulating material at least on the side proximate bus bar 1980 or an insulating material may be applied to the bus bar 1980 to avoid inadvertent electrical shorting between the spacer 1930 and the bus bar 1980. Alternatively, first spacer 1930 and/or second spacer 1932 may be a polymeric spacer.

In alternative embodiments, the examples of EC-VGU assembly 1800 in FIG. 18 and EC-VGU assembly 1900 in FIG. 19 may be oriented in the opposite direction. In the alternative embodiments, EC-VGU assembly 1800 includes an inboard lite having VGU 1801 and an outboard lite including laminate 1802 and/or EC-VGU assembly 1900 includes an inboard lite having VGU 1901 and an outboard lite including laminate 1902.

FIG. 20 depicts a schematic drawing of a cross-sectional view of an example of an dual EC-VGU assembly 2000, according to implementations. Dual EC-VGU assembly 2000 includes an outboard lite having a VGU 2001, an inboard lite having a VGU 2002, and a spacer 2032 between VGU 2001 and VGU 2002. VGU 2001 includes a first substrate 2010, a second substrate 2020, and a (first) edge spacer 2030 and inner spacers (e.g., inner spacers 2135 shown in FIG. 21) between first substrate 2010 and second substrate 2020. VGU 2001 also includes an electrochromic device coating 2040 disposed on an exterior-facing surface of second substrate 2020. VGU 2002 includes a third substrate 2025, a fourth substrate 2027, and a (second) edge spacer 2034 and inner spacers (e.g., inner spacers 2136 shown in FIG. 21) between third substrate 2025 and fourth substrate 2027. VGU 2002 also includes an electrochromic device coating 2042 disposed on an exterior-facing surface of the fourth substrate 2027. VGU 2001 includes a first interior region 2050 between edge spacer 2030, inner spacers (e.g., inner spacers 2135 shown in FIG. 21) and the interior-facing surfaces of first substrate 2010 and second substrate 2020. The first interior region 2050 is evacuated. EC-VGU assembly 2000 also includes a second interior region 2052 between spacer 2032 and interior-facing surfaces of second substrate 2020 and third substrate 2025. The second interior region 2052 is filled with an inert gas such as argon. VGU 2002 includes a third interior region 2054 between edge spacer 2034, inner spacers 2036 and interior-facing surfaces of the third substrate 2025 and fourth substrate 2027. The third interior region 2050 is evacuated.

FIG. 21 is a partial cross section of an EC-VGU assembly 2100 including an insulated glass unit having an inboard lite and an outboard lite substantially parallel to each other, according to implementations. The illustrated example shows a portion of the insulated glass unit near to and including an edge of the insulated glass unit. EC-VGU assembly 2100 in FIG. 21 and EC-VGU assembly 2000 in FIG. 20 have similar configurations and may have similar components. The outboard lite includes a VGU 2101 having a first substrate 2110, a second substrate 2120, and an edge spacer 2130 and inner spacers 2135 between first substrate 2110 and second substrate 2120. VGU 2101 also includes an electrochromic device coating 2140 disposed on an exterior-facing surface of second substrate 2120. The outboard lite includes a VGU 2102 having a third substrate 2125, a fourth substrate 2127, and an edge spacer 2134 and inner spacers 2136 between third substrate 2125 and fourth substrate 2127. VGU 2101 also includes an electrochromic device coating 2142 disposed on an exterior-facing surface of third substrate 2125. The electrochromic device coatings may be on the order of less than one micron thick to a few microns thick. A primary seal material 2137, e.g., PIB or other like adhesive sealant, is between first edge spacer 2130 and first substrate 2110, between first edge spacer 2130 and second substrate 2120, between second edge spacer 2134 and third substrate 2125, and between second edge spacer 2134 and fourth substrate 2127. The primary seal material 2137 may hermetically seal the interior regions 2150, 2154, which are evacuated. Around the primary seal of the VGU 2101 and between first substrate 2110 and second substrate 2120 is a secondary seal material 2138, which forms the secondary seal of the VGU 2101. Around the primary seal of the VGU 2102 and between third substrate 2125 and fourth substrate 2127 is a secondary seal material 2138, which forms the secondary seal of the VGU 2102. A primary seal material 2134 is between spacer 2132 and first substrate 2110 and between spacer 2132 and fourth substrate 2127. Primary seal material 2134 may serve to hermetically seal the interior region 2152 from the ambient. The interior region 2152 is charged with an inert gas such as argon. Around the perimeter of the primary seal and between and first substrate 2110 and fourth substrate 2127 is a sealant 2133, which forms the secondary seal of the IGU. In this example, the edges of the electrochromic device coating 2140 are within the primary seal material 2137 of the VGU 2101 and the edges of the electrochromic device coating 2142 are within the primary seal material 2137 of the VGU 2102. One or more bus bars may lie on the electrochromic device coating 2140 within the primary seal 2137 of the VGU 2101 and one or more bus bars may lie on the electrochromic device coating 2142 within the primary seal 2137 of the VGU 2102. In the illustrated example, a bus bar 2180 is disposed on electrochromic device coating 2140, between first spacer 2130 and the second substrate 2116, and within primary seal material 2137 and a bus bar 2182 is disposed on electrochromic device coating 2142, between spacer 2134 and the third substrate 2125, and within primary seal material 2137. Bus bar 2180 may be disposed on the first conductive layer or the second conductive layer of the electrochromic device coating 2140. Bus bar 2182 may be disposed on the first conductive layer or the second conductive layer of the electrochromic device coating 2142. Bus bars 2180 and 2182 may be between about 1 mm and about 5 mm wide, typically about 3 mm wide. In one implementation, spacer 2130 may be a metal spacer and/or spacer 2134 may be a metal spacer. In the spacer is a metal spacer, it may be coated with an insulating material at least on the side proximate bus bar 2180, 2182 or an insulating material may be applied to the bus bar 2180, 2182. Alternatively, spacer 2130 and/or spacer 2134 may be a polymeric spacer.

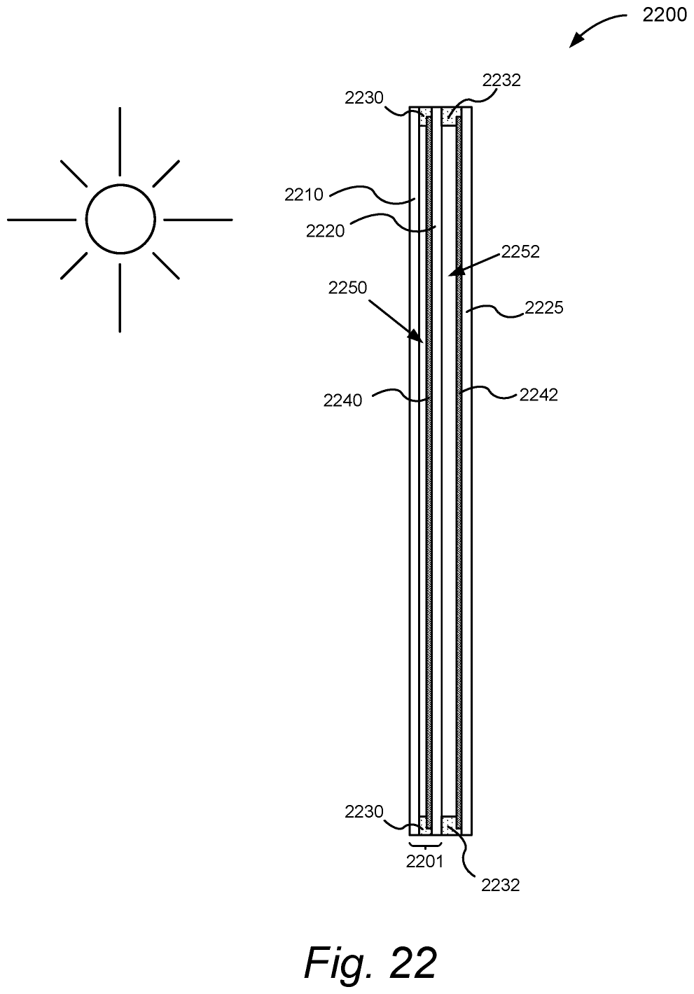

FIG. 22 depicts a schematic drawing of a cross-sectional view of an example of an EC-VGU assembly 2200 including an insulated glass unit having an inboard lite and an outboard lite substantially parallel to each other, according to implementations. The outboard lite includes a VGU 2201 with a first substrate 2210 and a second substrate 2220, and a first electrochromic device coating 2240 disposed on an exterior-facing surface of second substrate 2220 of the VGU 2201. The inboard lite includes a third substrate 2225. The insulated glass unit of EC-VGU assembly 2200 also includes a spacer 2232 between VGU 2201 and third substrate 2225. Third substrate 2224 includes a second electrochromic device coating 2242 disposed on an interior-facing surface. VGU 2201 includes an edge spacer 2232 and inner spacers (e.g., inner spacers 2335 shown in FIG. 23), all between first substrate 2210 and second substrate 2220. A first interior region 2250 lies between the edge spacer 2232 and the inner spacers (e.g., inner spacers 2335 shown in FIG. 23) and between the first substrate 2210 and the second substrate 2220. The first interior region 2250 is evacuated. A second interior region 2252 lies between spacer 2232 and both the second substrate 2220 and the third substrate 2225, which is filled with an inert gas such as argon.

FIG. 23 is a partial cross section of an EC-VGU assembly 2300 including an insulated glass unit having an inboard lite and an outboard lite substantially parallel to each other, according to implementations. The illustrated example shows a portion of the insulated glass unit near to and including an edge of the insulated glass unit, according to implementations. EC-VGU assembly 2300 in FIG. 23 and EC-VGU assembly 2200 in FIG. 22 have similar configurations and may have similar components. The outboard lite includes a VGU 2301 having a first substrate 2310, a second substrate 2320, and an edge spacer 2332 and inner spacers 2335 between first substrate 2310 and second substrate 2320. VGU 2301 also includes a first electrochromic device coating 2340 disposed on an exterior-facing surface of second substrate 2320 and includes a second electrochromic device coating 2342 on an interior-facing surface of third substrate 2325. The electrochromic device coatings may be on the order of less than one micron thick to a few microns thick. A primary seal material 2337, e.g., PIB or other like adhesive sealant, is between first spacer 2330 and first substrate 2310 and between spacer 2330 and second substrate 2320. The primary seal material 2337 may hermetically seal the interior region 2350, which is evacuated. Around the primary seal 2337 of VGU 2301 and between first substrate 2310 and second substrate 2320 is a secondary seal material 2338, which forms the secondary seal of the VGU 2301. A primary seal material 2334 is between spacer 2332 and second substrate 2320 and between spacer 2332 and third substrate 2325. Primary seal material 2334 serves to hermetically seal the interior region 2352 from the ambient. The interior region 2352 is charged with an inert gas such as argon. Around the perimeter of the primary seal and between and second substrate 2320 and third substrate 2325 is a sealant 2333, which forms the secondary seal of the insulated glass unit. In this example, the edges of the first electrochromic device coating 2340 are within the primary seal material 2337 of the VGU 2301 and the edges of the second electrochromic device coating 2342 are within the primary seal material 2334 of the insulated glass unit. One or more bus bars may lie on the first electrochromic device coating 2340 within the primary seal 2337 and one or more bus bars may lie on the second electrochromic device coating 2342 within the primary seal 2334. In this example, a bus bar 2380 is disposed on electrochromic device coating 2340, between first spacer 2330 and the first substrate 2310, and within primary seal material 2337 and a bus bar 2382 is disposed on electrochromic device coating 2342, between first spacer 2332 and the third substrate 2325. Bus bar 2380 may be disposed on the first conductive layer or the second conductive layer of the electrochromic device coating 2340 and bus bar 2382 may be disposed on the first conductive layer or the second conductive layer of the electrochromic device coating 2342. Bus bar 2380 or bus bar 2382 may be between about 1 mm and about 5 mm wide, typically about 3 mm wide. In one implementation, spacer 2330 may be a metal spacer in which case, spacer 2330 may be coated with an insulating material at least on the side proximate bus bar 2380 or an insulating material may be applied to the bus bar 2380 to avoid inadvertent electrical shorting between the spacer 2330 and the bus bar 2380. In one implementation, spacer 2332 may be, alternatively or additionally, a metal spacer in which case, spacer 2332 may be coated with an insulating material at least on the side proximate bus bar 2382 or an insulating material may be applied to the bus bar 2382 to avoid inadvertent electrical shorting between spacer 2332 and bus bar 2382. Alternatively, first spacer 2330 and/or second spacer 2332 may be a polymeric spacer.

In alternative embodiments, the examples of the EC-VGU assembly 2200 in FIG. 22 and the EC-VGU assembly 2300 in FIG. 23 may be oriented in the opposite direction. In the alternative embodiments, EC-VGU assembly 2200 includes an inboard lite having VGU 2201 and a third substrate 2225 that is outboard of VGU 2202 and/or EC-VGU assembly 2300 includes an inboard lite having VGU 2301 and a third substrate 2325 that is outboard of VGU 2302.

FIG. 24 depicts a schematic drawing of a cross-sectional view of an example of an EC-VGU assembly 2400 including an insulated glass unit having an outboard lite that includes a VGU 2401 having a first substrate 2410 and a second substrate 2420, an inboard lite that includes a laminate 2402 having a third substrate 2425 and a fourth substrate 2427, and a spacer 2432 between the VGU 2401 and the third substrate 2425, according to implementations. Third substrate 2425 and fourth substrate 2427 are laminated together with a lamination adhesive 2426. A first electrochromic device coating 2440 is disposed on an exterior-facing surface of the second substrate 2420 of VGU 2401 and a second electrochromic device coating 2440 is disposed between the third substrate 2425 and the fourth substrate 2427 of the laminate 2402, e.g., within lamination adhesive 2426. VGU 2401 also includes an edge spacer 2430 and inner spacers (e.g., inner spacers 2535 shown in FIG. 25), all between first substrate 2410 and second substrate 2420. A first interior region 2450 lies between edge spacer 2430 and inner spacers e.g., inner spacers 2535 shown in FIG. 25), and the first substrate 2410 and the second substrate 2420. The first interior region 2450 is evacuated. A second interior region 2452 lies between spacer 2432 and both the second substrate 2420 and the third substrate 2425. The second interior region 2452 is filled with an inert gas such as argon. In this example, second electrochromic device coating 2442 is disposed on the substrate 2424 and lamination adhesive layer 2426 is disposed between the second electrochromic device coating 2442 and substrate 2427. In another implementation, second electrochromic device coating 2442 is disposed on substrate 2427 and lamination adhesive layer 2426 is disposed between second electrochromic device coating 2442 and substrate 2425.

FIG. 25 is a partial cross section of an EC-VGU assembly 2500 including an insulated glass unit having an inboard lite and an outboard lite substantially parallel to each other, according to implementations. The illustrated example shows a portion of the insulated glass unit near to, and including, an edge of the insulated glass unit. EC-VGU assembly 2500 in FIG. 25 and EC-VGU assembly 2400 in FIG. 24 are similar configurations and may have similar components. The outboard lite includes a VGU 2501 having a first substrate 2510, a second substrate 2520, and an edge spacer 2532 and inner spacers 2535 between first substrate 2510 and second substrate 2520. VGU 2501 also includes a first electrochromic device coating 2540 disposed on an exterior-facing surface of second substrate 2520. The inboard lite includes a laminate 2502 having a second electrochromic device coating 2542 between third substrate 2525 and fourth substrate 2527. The electrochromic device coatings 2540, 2542 may be on the order of less than one micron thick to a few microns thick. A primary seal material 2537, e.g., PIB or other like adhesive sealant, is between first spacer 2530 and first substrate 2510 and between spacer 2530 and second substrate 2520. The primary seal material 2537 may hermetically seal the interior region 2550, which is evacuated. Around the primary seal 2537 of VGU 2501 and between first substrate 2510 and second substrate 2520 is a secondary seal material 2538, which forms the secondary seal of VGU 2501. A primary seal material 2534 is between spacer 2532 and second substrate 2520 and between spacer 2532 and third substrate 2525. Primary seal material 2534 serves to hermetically seal the interior region 2552 from the ambient. The interior region 2552 is charged with an inert gas such as argon. Around the perimeter of the primary seal and between and second substrate 2520 and third substrate 2525 is a sealant 2533, which forms the secondary seal of the insulated glass unit. In this example, the edges of the first electrochromic device coating 2540 are within the primary seal material 2537 of VGU 2501 and the edges of the second electrochromic device coating 2542 are within the lamination adhesive 2526 of the laminate 2502. One or more bus bars may lie on the first electrochromic device coating 2540 within the primary seal 2537 and one or more bus bars may lie on the second electrochromic device coating 2542 within the lamination adhesive 2526. In this example, a bus bar 2580 is disposed on electrochromic device coating 2540, between first spacer 2530 and second substrate 2520, and within primary seal material 2537 and a bus bar 2582 is connected (e.g., disposed on) second electrochromic device coating 2542, at the edge of the adhesive layer 2526. Bus bar 2580 may be disposed on the first conductive layer or the second conductive layer of the electrochromic device coating 2540 and bus bar 2582 may be disposed on the first conductive layer or the second conductive layer of the electrochromic device coating 2542. Bus bar 2580 or bus bar 2582 may be between about 1 mm and about 5 mm wide, typically about 3 mm wide. In one implementation, spacer 2530 may be a metal spacer, in which case, spacer 2530 may be coated with an insulating material at least on the side proximate bus bar 2580 or an insulating material may be applied to the bus bar 2580 to avoid inadvertent electrical shorting between the spacer 2530 and the bus bar 2580. Alternatively, first spacer 2530 and/or second spacer 2532 may be a polymeric spacer. In the illustrated example, second electrochromic device coating 2542 is disposed on the substrate 2525 and lamination adhesive layer 2526 is disposed between the second electrochromic device coating 2542 and substrate 2527. In another implementation, second electrochromic device coating 2542 is disposed on substrate 2527 and lamination adhesive layer 2526 is disposed between second electrochromic device coating 2542 and substrate 2525.

In alternative embodiments, the examples of the EC-VGU assembly 2400 in FIG. 24 and/or EC-VGU assembly 2500 in FIG. 25 may be oriented in the opposite direction. In the alternative embodiments, EC-VGU assembly 2400 may includes an inboard lite having VGU 2401 and an outboard lite that includes laminate 2402 and/or EC-VGU assembly 2500 may include an inboard lite having VGU 2501 and an outboard lite that includes laminate 2502. Whatever the shape of an optical device (e.g., an electrochromic device), it can be incorporated into an insulated glass unit (IGU) or vacuum insulated glass unit (VGU). In some aspects, the electrochromic device is configured inside the IGU and/or VGU so as to protect it from moisture and the ambient.

Multi-pane electrochromic windows with IGUs having two or more electrochromic lites are described in U.S. patent application Ser. No. 12/851,514, filed on Aug. 5, 2010, and titled “Multipane Electrochromic Windows,” which is incorporated by reference herein for all purposes. One advantage to such multipane electrochromic windows is that the likelihood of two defects aligning perfectly, and thus being observable to the end user, is quite small. Another advantage may be the low transmissivity of the window when the multiple electrochromic devices are in a darkened tint state. This may be particularly advantageous for windows used for privacy such as windows in a hospital.

In certain embodiments, a lite includes at least one substrate such as a glass sheet. The glass sheet may be up to 5 mm or even up to 6 mm thick (up to ¼ inch). In some embodiments, one or more substrates of an IGU are strengthened. For example, strengthening may include laminating one or more of the substrates of an IGU with, for example, a thicker pane of float glass, a pane of tempered glass, a polymeric pane such as plexiglass, a pane of Gorilla Glass, and the like. In another embodiment, strengthening includes applying a polymeric coating to one or more substrates of the IGU. Examples of such polymeric coatings include ormosil polymeric coatings (epoxy resin, an amine hardener and a silane), sol-gel coatings, acrylic glazes, and other safety glazes, for example commercially available glazes which meet one or more impact test standards.

In certain embodiments, opposing bus bars on each conductor layer of an electrochromic device are used. In one embodiment, the at least one exposed area of the first conductor layer includes a pair of strips, each strip of the pair of strips on opposing sides of the first conductor layer proximate the perimeter area of the transparent substrate. Depending upon the shape of the device, the strips may be linear or curved, for example. The strips can include a first pair of bus bars, each of the first pair of bus bars on and within the area of each strip of the pair of strips. A second pair of bus bars on the second conductor layer can be included, each of the second pair of bus bars configured to be on or disposed on each of two portions of the second conductor layer that do not cover the first conductor layer, each of the two portions proximate the perimeter area and on opposing sides of the second conductor layer.

The first and second conductor layers and the one or more material layers of optical devices described herein may be all solid-state and inorganic. In one embodiment, the substrate is float glass, tempered or untempered, and the first conductor layer includes tin oxide, e.g. fluorinated tin oxide. The substrate may be registered in an IGU with an additional EC device or not. As described, the bus bars, any laser scribes, device edges, and/or exposed portions of the first conductor layer may be sealed in the primary seal of the IGU.

In certain embodiments, when laminating, bus bar ink may be applied prior to lamination, where the ink is applied to the BPE and upper TCO, then pressed out from between these areas when laminated, e.g. to an aperture in the mate lite or continuing around the edge of the laminate, to allow lead attach at a point located outside the laminated area. In another embodiment, a flat foil tape is applied to the top conductor and the BPE, the foil tape extends beyond the laminated region, such that wires can be soldered to the tape after lamination. In these embodiments, cutting must precede lamination unless, e.g., the lamination mate lites do not cover the entire surface of the large format substrate (e.g. as described in relation to roll-to-roll embodiments herein).

In some cases, thin flexible substrates may be used as strengthening panes (mate lites) for EC lites (i.e. lites with one or more electrochromic devices), e.g., such as EC lites fabricated as described herein. In certain embodiments, thin flexible substrates are used as substrates for the EC lite fabrication process. For example, one embodiment includes any of the EC device fabrication methods described herein performed on a thin flexible substrate as described herein, e.g. Gorilla® Glass or Willow™ Glass. In some embodiments, fabrication is performed using a roll-to-roll fabrication scheme.

Although the foregoing embodiments have been described in some detail to facilitate understanding, the described embodiments are to be considered illustrative and not limiting. It will be apparent to one of ordinary skill in the art that certain changes and modifications can be practiced within the scope of the above description and the appended claim

1. An electrochromic vacuum insulated glass unit, comprising a first electrochromic device and a first vacuum insulated glass unit.

2. The electrochromic vacuum insulated glass unit of claim 1, wherein the first electrochromic device is in or on the first vacuum insulated glass unit.

3. The electrochromic vacuum insulated glass unit of claim 2, wherein the first electrochromic device is within an evacuated volume of the first vacuum insulated glass unit.

4. The electrochromic vacuum insulated glass unit of claim 3, wherein the first electrochromic device is reflective and/or absorptive.

5. The electrochromic vacuum insulated glass unit of claim 1, wherein the first vacuum insulated glass unit comprises a first substrate and a second substrate.

6. The electrochromic vacuum insulated glass unit of claim 5, wherein the first electrochromic device is disposed on an inner surface of one of the first and second substrates.

7. The electrochromic vacuum insulated glass unit of claim 5, further comprising a third substrate.

8. The electrochromic vacuum insulated glass unit of claim 7, wherein the third substrate is laminated with a lamination adhesive to an outer surface of the one of the first and second substrates on which the first electrochromic device is disposed.

9. The electrochromic vacuum insulated glass unit of claim 7, further comprising:
a spacer; and
a primary seal (i) between the spacer and the first vacuum insulated glass unit and (ii) between the spacer and the third substrate, wherein the primary seal is configured to seal a gas-filled interior region between the first vacuum insulated glass unit and the third substrate.

10. The electrochromic vacuum insulated glass unit of claim 9, further comprising a second electrochromic device disposed on an inner surface of the third substrate.

11. (canceled)

12. The electrochromic vacuum insulated glass unit of claim 9, further comprising a fourth substrate laminated to the outer surface of the third substrate.

13. The electrochromic vacuum insulated glass unit of claim 12, further comprising a second electrochromic device disposed between the third substrate and the fourth substrate.

14. (canceled)

15. The electrochromic vacuum insulated glass unit of claim 5, further comprising a second vacuum insulated glass unit and a second electrochromic device within an evacuated volume of the second vacuum insulated glass unit.

16. The electrochromic vacuum insulated glass unit of claim 15, wherein the second electrochromic device is disposed on an inner surface of a substrate of the second vacuum insulated glass unit.

17. (canceled)

18. The electrochromic vacuum insulated glass unit of claim 5, wherein the first vacuum insulated glass unit further comprises:
an edge spacer along a perimeter of the first vacuum insulated glass unit, between the first substrate and the second substrate;
one or more inner spacers between the first substrate and the second substrate; and
a primary seal between the first and second substrates and the edge spacer and the one or more inner spacers.

19. The electrochromic vacuum insulated glass unit of claim 18, wherein the primary seal is configured to hermetically seal the evacuated volume of the first vacuum insulated glass unit.

20. The electrochromic vacuum insulated glass unit of claim 18, wherein at least a portion of a perimeter edge of the first electrochromic device is within the primary seal.

21. (canceled)

22. The electrochromic vacuum insulated glass unit of claim 18, further comprising at least one bus bar disposed on a conductive layer of the first electrochromic device.

23. The electrochromic vacuum insulated glass unit of claim 22, wherein the at least one bus bar lies between the edge spacer and the substrate on which the first electrochromic device is disposed.

24. The electrochromic vacuum insulated glass unit of claim 23, wherein the at least one bus bar lies within the primary seal.

25. The electrochromic vacuum insulated glass unit of claim 2, wherein the first electrochromic device is not within an evacuated volume of the first vacuum insulated glass unit.

26. (canceled)

27. The electrochromic vacuum insulated glass unit of claim 25, wherein the first vacuum insulated glass unit comprises at least two substrates, wherein the first electrochromic device is disposed on an outer surface of one of the at least two substrates.

28. The electrochromic vacuum insulated glass unit of claim 25, wherein the first vacuum insulated glass unit comprises a first substrate, a second substrate, and a third substrate laminated to the second substrate.

29. The electrochromic vacuum insulated glass unit of claim 28, wherein the first electrochromic device is disposed between the second substrate and the third substrate.

30. The electrochromic vacuum insulated glass unit of claim 29, wherein the first vacuum insulated glass unit further comprises:
an edge spacer along a perimeter of the first vacuum insulated glass unit, between the first substrate and the second substrate;
one or more inner spacers between the first substrate and the second substrate; and
a primary seal between the first and second substrates and the edge spacer and the one or more inner spacers.

31. The electrochromic vacuum insulated glass unit of claim 25, further comprising a second vacuum insulated glass unit, the first electrochromic device disposed between substrates of the first and second vacuum insulated glass units.

32. The electrochromic vacuum insulated glass unit of claim 31, wherein at least one vacuum insulated glass unit of the first vacuum insulated glass unit and the second vacuum insulated glass unit comprises:
an edge spacer along a perimeter of the at least one vacuum insulated glass unit, between the first substrate and the second substrate;
one or more inner spacers between the first substrate and the second substrate; and
a primary seal between the first and second substrates and the edge spacer and the one or more inner spacers.

33. The electrochromic vacuum insulated glass unit of claim 2, wherein the first vacuum insulated glass unit comprises a first substrate and a second substrate, and wherein the electrochromic vacuum insulated glass unit further comprises a third substrate.

34. The electrochromic vacuum insulated glass unit of claim 33, further comprising a fourth substrate laminated to an outer surface of the third substrate.

35. The electrochromic vacuum insulated glass unit of claim 33, further comprising:
a spacer; and
a primary seal (i) between the spacer and the first vacuum insulated glass unit and (ii) between the spacer and the second substrate, wherein the primary seal is configured to seal a gas-filled interior region between the first vacuum insulated glass unit and the third substrate.

36. The electrochromic vacuum insulated glass unit of claim 35, wherein the first electrochromic device is disposed on an inner surface of the third substrate.

37. The electrochromic vacuum insulated glass unit of claim 35, further comprising a fourth substrate laminated to an outer surface of the third substrate, wherein the first electrochromic device is disposed between the third substrate and the fourth substrate.
